(19) United States
(12) Patent Application Publication
(10) Pub. No.: US 2008/0274881 A1
(43) Pub. Date: Nov. 6, 2008

(54) THERMOSENSITIVE TRANSFER INK SHEET, AND IMAGE FORMING METHOD

(75) Inventors: Toshio Shimada, Kanagawa (JP); Yoshihiko Fujie, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/058,611

(22) Filed: Mar. 28, 2008

(30) Foreign Application Priority Data
Mar. 29, 2007 (JP) 2007-089296

(51) Int. Cl. B41M 5/24; B41M 5/00

(52) U.S. Cl. 503/201; 428/32.52

(57) ABSTRACT

Provided are a thermosensitive transfer ink sheet making it possible to overcome blocking and sticking and further giving a print having a high Dmax and a high image quality; and an image forming process using the same. The sheet is a thermosensitive transfer ink sheet including a base film which has, over one surface thereof, at least a thermal transfer layer containing a thermally transferable dye and a binder resin, and has, over the other surface thereof, a heat-resistant lubricant layer, wherein the thermal transfer layer comprises a polycondensed aromatic compound having 4 or more rings; and the above-mentioned process is an image forming process using the sheet.

### CROSS-REFERENCE TO RELATED APPLICATION

This application claims priority under 35USC119 from Japanese Patent Application No. 2007-089296, the disclosure of which is incorporated by reference herein.

### BACKGROUND OF THE INVENTION

1. Field of the Invention

The invention relates to a thermosensitive transfer ink sheet for overcoming print failure due to blocking and further obtaining a print having a high Dmax and a high image quality, and an image forming method using the same.

2. Description of the Related Art

At present, various thermal transfer recording methods are known. Attention is paid in particular to the dye diffusion transfer recording method as a process making it possible to produce a color hard copy closest to silver salt photography in image quality (see, for example, “New Development of Information Recording (Hard Copy) and Material thereof”, published by Toray Research Center Inc., 1993, pp. 241-285 and “Development of Printer Material”, published by CMC Publishing Co., Ltd., 1995, p. 180). Additionally, compared to silver salt photography, this recording method has advantages such as that the process is a dry process, a visible image can be produced directly from digital data, and duplicates are easily produced.

In this dye diffusion transfer recording method, a thermosensitive transfer ink sheet containing a dye (which may be referred to briefly as a thermosensitive transfer sheet or ink sheet hereinafter) and a thermosensitive transfer image-receiving sheet (which may be referred to briefly as an image-receiving sheet hereinafter) overlap each other, and then, the ink sheet is heated by a thermal head whose heat generation is controlled by electric signals, thereby transferring the dye in the ink sheet to the image-receiving sheet so as to record image data. A color image having a continuous change in the tone of color can be transfer-recorded by recording three colors of cyan, magenta and yellow, or four colors including black in addition to these colors in the state that they overlap.

In order to improve the developability of colors in this process, the use of various colors is suggested (see, for example, U.S. Pat. Nos. 5,532,202, 5,260,257, 5,158,928, and 4,764,178). However, when this process is compared with silver salt photography, which has a long history as color print material, there remains a problem that in images obtained by continuous processing the generation ratio of defective images is high. In particular, in conjunction with the ongoing acceleration of printing speeds, a larger amount of heat is imparted from the thermal head to the ink sheet at the time of printing. As a result, creases (which may be referred to as ribbon creases hereinafter) may occur at the ink sheet, causing transfer failure. Alternatively, adhesiveness between an ink sheet and an image-receiving sheet may increase, causing blocking or sticking. These problems not only affect the supply of a high image quality print, but also affect profitability by preventing a higher speed of printing.

Blocking and sticking occur when the releasability between an ink sheet and an image-receiving sheet is insufficient. As a countermeasure against this problem, a method of adding a releasing agent, which is selected from various compounds, typical examples of which are silicone compounds, to an ink sheet and/or an image-receiving sheet (see, for example, Japanese Patent Application Laid-Open (JP-A) No. 09-202058), and a method of adding fine particles such as a matting agent or the like to an ink sheet and/or an image-receiving sheet (see, for example, JP-A No. 06-40171) have been suggested. However, it is known that if the added amount of such a releasing agent is increased, the generation frequency of ribbon creases is increased remarkably. Thus, the development of a releasing agent capable of improving blocking and sticking without causing ribbon creases is desired.

Furthermore, if the added amount of a releasing agent is large, the ratio of the dye which is included in a thermal transfer layer (which may be referred to simply as an ink layer hereinafter) becomes relatively low, thereby resulting in lowering the Dmax and image quality. Therefore, it is difficult to achieve both releasability and high Dmax.

### SUMMARY OF THE INVENTION

The present invention has been made in view of the above circumstances and provides a thermosensitive transfer ink sheet, and an image forming method.

A first aspect of the present invention provides a thermosensitive transfer ink sheet comprising a base film which has, over one surface thereof, a thermal transfer layer containing at least a thermally transferable dye and a binder resin, and has, over the other surface thereof, a heat-resistant lubricant layer, wherein the thermal transfer layer comprises a polycondensed aromatic compound having 4 or more rings.

A second aspect of the present invention provides an image forming method, comprising:

putting a thermosensitive transfer ink sheet comprising a base film which has, over one surface thereof, a thermal transfer layer containing at least a thermally transferable dye and a binder resin, and has, over the other surface thereof, heat-resistant lubricant layer wherein the thermal transfer layer comprises a polycondensed aromatic compound having 4 or more rings onto a thermosensitive transfer image-receiving sheet which has a support, at least one dye receiving layer over the support, and at least one heat insulating layer arranged between the dye receiving layer and the support and containing hollow polymer particles and a hydrophilic polymer to bring the thermal transfer layer of the thermosensitive transfer ink sheet into contact with the dye receiving layer of the thermosensitive transfer image-receiving sheet;

and applying thermal energy corresponding to an image signal thereto from a thermal head.

### BRIEF DESCRIPTION OF THE DRAWING

FIGS. 1A, 1B and 1C are each a schematic view illustrating an example of the arrangement of inks on a thermosensitive transfer ink sheet of the invention.

FIGS. 2D, 2E, 2F, and 2G are each a schematic view illustrating an example of a thermosensitive transfer ink sheet of the invention wherein ink layers (dye layers) are formed on different supports, respectively.

FIG. 3 is a schematic sectional view illustrating an example of the arrangement of inks on a thermosensitive transfer ink sheet of the invention.

### DETAILED DESCRIPTION OF THE INVENTION

The present invention has been made in view of the above circumstances. The invention provides an ink sheet that can overcome blocking and sticking and obtain a print having both high Dmax and high image quality without print failure resulting from ribbon creases. Furthermore, the invention provides a method of forming an image using the ink sheet.

Inventors of the invention have repeated investigations carefully and find out that the problem may be solved by incorporating a polycondensed aromatic compound having 4 or more rings into a thermal transfer layer containing a thermally transferable dye and a binder resin. Although details in a working mechanism are not definite, a releasing agent which has been hitherto used, such as silicone compounds, has effects for lowering a peel ability between an ink sheet and an image-receiving sheet but lowers strength of an ink sheet in a case of print, thereby causing ribbon creases. However, a polycondensed aromatic compound having 4 or more rings, employed in the invention, is presumed to keep strength of an ink sheet and simultaneously to have an effect for lowering a peel ability.

Accordingly, a thermosensitive transfer ink sheet of the present invention is a thermosensitive transfer ink sheet, comprising a base film which has, over one surface thereof, a thermal transfer layer containing at least a thermally transferable dye and a binder resin, and has, over the other surface thereof, a heat-resistant lubricant layer, wherein the thermal transfer layer comprises a polycondensed aromatic compound having 4 or more rings.

While an image forming method of the present invention is an image forming method, comprising:

putting a thermosensitive transfer ink sheet comprising a base film which has, over one surface thereof, a thermal transfer layer containing at least a thermally transferable dye and a binder resin, and has, over the other surface thereof, heat-resistant lubricant layer wherein the thermal transfer layer comprises a polycondensed aromatic compound having 4 or more rings onto a thermosensitive transfer image-receiving sheet which has a support, at least one dye receiving layer over the support, and at least one heat insulating layer arranged between the dye receiving layer and the support and containing hollow polymer particles and a hydrophilic polymer to bring the thermal transfer layer of the thermosensitive transfer ink sheet into contact with the dye receiving layer of the thermosensitive transfer image-receiving sheet;

and applying thermal energy corresponding to an image signal thereto from a thermal head.

The invention will be described in detail hereinafter.

1) Thermosensitive Transfer Ink Sheet

The thermosensitive transfer ink sheet used in the invention is first described.

When a thermal transfer image is formed, a thermosensitive transfer ink sheet, which is used together with the aforementioned thermosensitive transfer image-receiving sheet, is a sheet wherein a thermal transfer layer (which may be referred to briefly as a thermal transfer layer or a dye layer hereinafter) containing a diffusion transfer dye and a binder resin is formed on a base film (which may be referred to briefly as a support hereinafter).

Next, a polycondensed aromatic compound having 4 or more rings, contained in the thermal transfer layer in the invention, will be described in detail.

This polycondensed aromatic compound having 4 or more rings is an aromatic compound wherein at least 4 rings are condensed. The condensed rings may be in any form. The number of the rings is not particularly limited as long as the number is 4 or more. The number of the rings which constitute the condensed rings is actually 20 or less, preferably 15 or less, more preferably 10 or less. Each of the rings constituting the condensed rings may be an aromatic ring or an alicyclic ring, and may be an alicyclic heteroring, or an aromatic heteroring; it is indispensable that at least one of the rings is an aromatic ring or an aromatic heteroring so that the compound is classified, as a whole, into an aromatic compound.

In the invention, the polycondensed aromatic compound having 4 or more rings is preferably a phthalocyanine compound, a chlorophyllin compound or a triphenylene compound, and is more preferably a phthalocyanine compound, or a triphenylene compound.

The following will describe a phthalocyanine compound, which is preferred in the invention.

The phthalocyanine compound specified in the invention may be preferably a naphthocyanine compound, and is more preferably a compound represented by the formula (1) illustrated below.

Any phthalocyanine compound is a typical compound as a dye, and typical examples thereof include phthalocyanine and Color Index Direct Blue 199. Preferred are also compounds described in JP-A Nos. 2003-3109 and 2003-3086.

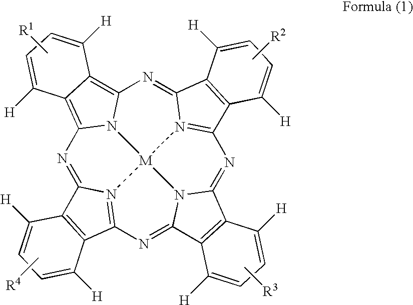

In the formula (1), R¹, R², R³ and R⁴ each independently represents a hydrogen atom, or a monovalent substituent, and M represents a hydrogen atom, or a metal element, or an oxide, hydroxide or halide thereof.

In the formula (1), M represents a hydrogen atom, or a metal element, or an oxide, hydroxide or halide thereof. Preferred examples of M include a hydrogen atom; and metal elements such as Li, Na, K, Mg, Ti, Zr, V, Nb, Ta, Cr, Mo, W, Mn, Fe, Co, Ni, Ru, Rh, Pd, Os, Ir, Pt, Cu, Ag, Au, Zn, Cd, Hg, Al, Ga, In, Si, Ge, Sn, Pd, Sb, and Bi. Examples of the oxide include VO, and GeO. Examples of the hydroxide include Si(OH)₂, Cr(OH)₂, and Sn(OH)₂. Examples of the halide include AlCl, SiCl₂, VCl, VCl₂, VOCl, FeCl, GaCl, and ZrCl. In particular, Cu, Ni, Zn and Al are preferred, and Cu is most preferred.

In the formula (1), R¹, R², R³ and R⁴ each independently represents a hydrogen atom, or a monovalent substituent. Preferred examples of the monovalent substituent include halogen atoms; and alkyl, cycloalkyl, alkenyl, aralkyl, aryl, heterocyclic, cyano, hydroxy, nitro, amino, alkylamino, alkoxy, aryloxy, amide, arylamino, ureido, sulfamonylamino, alkylthio, arylthio, alkoxycarbonylamino, sulfonamide, carbamoyl, sulfamoyl, alkoxycarbonyl, heterocyclic oxy, azo, acyloxy, carbamoyloxy, silyloxy, aryloxycarbonyl, aryloxycarbonylamino, imide, heterocyclic thio, phosphoryl, acyl, sulfoxide, and sulfonyl groups. In particular, sulfoxide and sulfonyl groups are preferred, and a sulfonyl group is most preferred.

When the above-mentioned monovalent substituent is a group which may further have a substituent, the former substituent may have one or more selected from substituents as described below.

Halogen atoms (for example, chlorine, and bromine atoms); linear or branched alkyl groups having 1 to 12 carbon atoms (for example, methyl, ethyl, propyl, isopropyl, t-butyl, 2-methanesulfonylethyl, 3-phenoxypropyl, and trifluoromethyl groups), aralkyl groups having 7 to 18 carbon atoms, alkenyl groups having 2 to 12 carbon atoms, linear or branched alkynyl groups having 2 to 12 carbon atoms, linear or branched cycloalkyl groups having 3 to 12 carbon atoms (for example, a cyclopentyl group), and linear or branched cycloalkenyl groups having 3 to 12 carbon atoms; aryl groups (for example, phenyl, 4-t-butylphenyl, and 2,4-di-t-amylphenyl groups); heterocyclic groups (for example, imidazolyl, pyrazolyl, triazolyl, 2-furyl, 2-thienyl, 2-pyrimidyl, and 2-benzothiazolyl groups); a cyano group; a hydroxyl group; a nitro group; a carboxyl group; an amino group; alkyloxy groups (for example, methoxy, ethoxy, 2-methoxyethoxy, and 2-methanesulfonylethoxy groups); aryloxy groups (for example, phenoxy, 2-methylphenoxy, 4-t-butylphenoxy, 3-nitrophenoxy, and 3-t-butyloxycarbamoylphenoxy groups);

acylamino groups (for example, acetoamide, benzamide, and 4-(3-t-butyl-4-hydroxyphenoxy)butaneamide groups); alkylamino groups (for example, methylamino, butylamino, diethylamino, and methylbutylamino groups); anilino groups (for example, phenylamino, and 2-chloroanilino groups); ureido groups (for example, phenylureido, methylureido, and N,N-dibutylureido groups); sulfamoylamino groups (for example, an N,N-dipropylsulfamoylamino group); alkylthio groups (for example, methylthio, octylthio, and 2-phenoxyethylthio groups); arylthio groups (for example, phenylthio, 2-butoxy-5-t-octylphenylthio, and 2-carboxyphenylthio groups); alkyloxycarbonylamino groups (for example, a methoxycarbonylamino group); sulfonamide groups (for example, methanesulfoamide, benzenesulfoamide, p-toluenesulfonamide, and octadecanesulfonamide groups);

carbamoyl groups (for example, N-ethylcarbamoyl, and N,N-dibutylcarbamoyl groups); sulfamoyl groups (for example, N-ethylsulfamoyl, N,N-dipropylsulfamoyl, and N,N-diethylsulfamoyl groups); sulfonyl groups (for example, methanesulfonyl, octanesulfonyl, benzenesulfonyl, and toluenesulfonyl groups); alkyloxycarbonyl groups (for example, methoxycarbonyl, and butyloxycarbonyl groups); heterocyclic oxy groups (for example, 1-phenyltetrazole-5-oxy, and 2-tetrahydropyranyloxy groups); azo groups (for example, phenylazo, 4-methoxyphenylazo, 4-pivaloylaminophenylazo, and 2-hydroxy-4-propanoylphenylazo groups); acyloxy groups (for example, an acetoxy group); carbamoyloxy groups (for example, N-methylcarbamoyloxy, and N-phenylcarbamoyloxy groups); silyloxy groups (for example, trimethylsilyloxy, and dibutylmethylsilyloxy groups); aryloxycarbonylamino groups (for example, a phenoxycarbonylamino group); imide groups (for example, N-succinimide, and N-phthalimide groups); heterocyclic thio groups (for example, 2-benzothiazolylthio, 2,4-di-phenoxy-1,3,5-triazole-6-thio, and 2-pyridylthio groups); sulfinyl groups (for example, a 3-phenoxypropylsulfinyl group); phosphoryl groups (for example, phenoxyphosphoryl, octyloxyphosphoryl, and phenylphosphoryl groups); aryloxycarbonyl groups (for example, a phenoxycarbonyl group); and acyl groups (for example, acetyl, 3-phenylpropanoyl, and benzoyl groups).

Specific examples of the phthalocyanine derivatives used in the invention are shown in Table 1 described below (exemplified compounds P-1 to P-10). However, the phthalocyanine derivatives used in the invention are not limited to the examples illustrated below.

[TABLE 1]

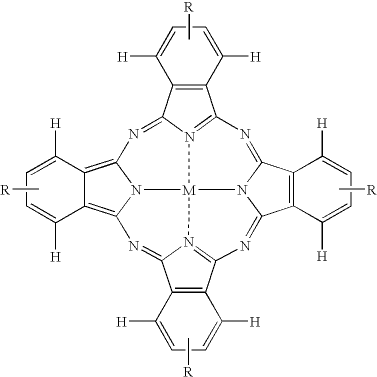

Compound

| No. | M | R |
|---|---|---|
| P-1 | Cu | —SO₂(CH₂)₃SO₂NH(CH₂)₃OCH(CH₃)₂ |
| P-2 | Cu | —SO₂(CH₂)₃SO₂NHCH(CH₃)₂ |
| P-3 | Cu | —SO₂(CH₂)₃SO₂NH(CH₂)₂N(CH₃)₂ |
| P-4 | Cu | —SO₂(CH₂)₃SO₂NH(CH₂)₄OCH(CH₃)₂ |
| P-5 | Cu | —SO₃(CH₂)₃SO₂NH(CH₂)₅OCH(CH₃₎₂ |
| P-6 | Cu | —SO₂(CH₂)₃SO₂NH(CH₂)₃O(CH₂)₂CH₃ |
| P-7 | Cu | —SO₂(CH₂)₃SO₂NH(CH₂)₃OCH(CH₃) CH₂CH₃ |
| P-8 | Cu | —SO₂(CH₂)₃SO₂NH(CH₂)₃OCH(CH₃₎₂ |
| P-9 | Zi | —SO₂(CH₂)₃SO₂NHCH₂CH₃ |
| P-10 | Ni | —SO₂(CH₂)₃CONH(CH₂)₃OCH(CH₃)₂ |

The following will describe a triphenylene compound, which is another preferred compound of the polycondensed aromatic compound having 4 or more rings, in detail.

Triphenylene derivatives are described as discotic liquid crystal compounds in, for example, C. Destrade et al., Research Report, Mol. Cryst. Liquid. Cryst. Vol. 71, p. 111 (1981). These are also preferred for the invention.

In the invention, a compound represented by the following formula (2) is more preferred:

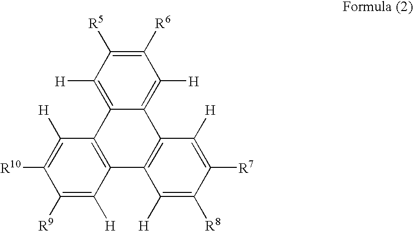

In the formula (2), R⁵, R⁶, R⁷, R⁸, R⁹ and R¹⁰ each independently represents a hydrogen atom or a monovalent substituent.

In the formula (2), R⁵, R⁶, R⁷, R⁸, R⁹ and R¹⁰ each independently represents a hydrogen atom or a monovalent substituent. Preferred examples of the monovalent substituent include halogen atoms; and alkyl, cycloalkyl, alkenyl, aralkyl, aryl, heterocyclic, cyano, hydroxy, nitro, amino, alkylamino, alkoxy, aryloxy, alkylcarbonyloxy, arylcarbonyloxy, amide, arylamino, ureido, sulfamonylamino, alkylthio, arylthio, alkoxycarbonylamino, sulfonamide, carbamoyl, sulfamoyl, alkoxycarbonyl, heterocyclic oxy, azo, acyloxy, carbamoyloxy, silyloxy, aryloxycarbonyl, aryloxycarbonylamino, imide, heterocyclic thio, phosphoryl, acyl, sulfoxide, and sulfonyl groups. In particular, alkylcarbonyloxy and arylcarbonyloxy groups are preferred, and an arylcarbonyloxy group is most preferred.

When the above-mentioned monovalent substituent is a group which may further have a substituent, the former substituent may have one or more selected from substituents as described below.

Halogen atoms (for example, chlorine, and bromine atoms); linear or branched alkyl groups having 1 to 12 carbon atoms (for example, methyl, ethyl, propyl, isopropyl, t-butyl, 2-methanesulfonylethyl, 3-phenoxypropyl, and trifluoromethyl groups), aralkyl groups having 7 to 18 carbon atoms, alkenyl groups having 2 to 12 carbon atoms, linear or branched alkynyl groups having 2 to 12 carbon atoms, linear or branched cycloalkyl groups having 3 to 12 carbon atoms (for example, a cyclopentyl group), and linear or branched cycloalkenyl groups having 3 to 12 carbon atoms; aryl groups (for example, phenyl, 4-t-butylphenyl, and 2,4-di-t-amylphenyl groups); heterocyclic groups (for example, imidazolyl, pyrazolyl, triazolyl, 2-furyl, 2-thienyl, 2-pyrimidinyl, and 2-benzothiazolyl groups); a cyano group; a hydroxyl group; a nitro group; a carboxyl group; an amino group; alkyloxy groups (for example, methoxy, ethoxy, 2-methoxyethoxy, and 2-methanesulfonylethoxy groups); aryloxy groups (for example, phenoxy, 2-methylphenoxy, 4-t-butylphenoxy, 3-nitrophenoxy, and 3-t-butyloxycarbamoylphenoxy groups); acylamino groups (for example, acetoamide, benzamide, and 4-(3-t-butyl-4-hydroxyphenoxy)butaneamide groups); alkylamino groups (for example, methylamino, butylamino, diethylamino, and methylbutylamino groups); anilino groups (for example, phenylamino, and 2-chloroanilino groups); ureido groups (for example, phenylureido, methylureido, and N,N-dibutylureido groups); sulfamoylamino groups (for example, an N,N-dipropylsulfamoylamino group); alkylthio groups (for example, methylthio, octylthio, and 2-phenoxyethylthio groups);

arylthio groups (for example, phenylthio, 2-butoxy-5-t-octylphenylthio, and 2-carboxyphenylthio groups); alkyloxycarbonylamino groups (for example, a methoxycarbonylamino group); sulfonamide groups (for example, methanesulfoamide, benzenesulfoamide, p-toluenesulfonamide, and octadecanesulfonamide groups); carbamoyl groups (for example, N-ethylcarbamoyl, and N,N-dibutylcarbamoyl groups); sulfamoyl groups (for example, N-ethylsulfamoyl, N,N-dipropylsulfamoyl, and N,N-diethylsulfamoyl groups); sulfonyl groups (for example, methanesulfonyl, octanesulfonyl, benzenesulfonyl, and toluenesulfonyl groups); alkyloxycarbonyl groups (for example, methoxycarbonyl, and butyloxycarbonyl groups); heterocyclic oxy groups (for example, 1-phenyltetrazole-5-oxy, and 2-tetrahydropyranyloxy groups); azo groups (for example, phenylazo, 4-methoxyphenylazo, 4-pivaloylaminophenylazo, and 2-hydroxy-4-propanoylphenylazo groups); acyloxy groups (for example, an acetoxy group); carbamoyloxy groups (for example, N-methylcarbamoyloxy, and N-phenylcarbamoyloxy groups); silyloxy groups (for example, trimethylsilyloxy, and dibutylmethylsilyloxy groups); aryloxycarbonylamino groups (for example, a phenoxycarbonylamino group); imide groups (for example, N-succinimide, and N-phthalimide groups); heterocyclic thio groups (for example, 2-benzothiazolylthio, 2,4-di-phenoxy-1,3,5-triazole-6-thio, and 2-pyridylthio groups); sulfinyl groups (for example, a 3-phenoxypropylsulfinyl group); phosphoryl groups (for example, phenoxyphosphoryl, octyloxyphosphoryl, and phenylphosphoryl groups); aryloxycarbonyl groups (for example, a phenoxycarbonyl group); and acyl groups (for example, acetyl, 3-phenylpropanoyl, and benzoyl groups).

Specific examples of the triphenylene derivative used in the invention are shown in Table 2 described below (exemplified compounds L-1 to L-10). However, the triphenylene derivatives used in the invention are not limited to the examples illustrated below.

[TABLE 2]

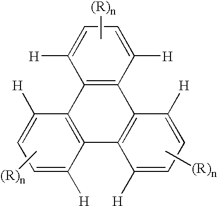

| Compound | | |
|---|---|---|
| No. | n | R |
| L-1 | 2 | —OCOC₆H₄O(CH₂)₄OCOCH═CH₂ |
| L-2 | 2 | —OCOC₆H₄O(CH₂)₃OCOCH═CH₂ |
| L-3 | 2 | —OCOC₆H₄O(CH₂)₂OCOCH═CH₂ |
| L-4 | 2 | —OCOC₆H₄O(CH₂)₅OCOCH═CH₂ |
| L-5 | 1 | —OCOC₆H₄O(CH₂)₆OCOCH═CH₂ |
| L-6 | 2 | —O(CH₂)₂O(CH₂)₂OCH₂CH₃ |
| L-7 | 2 | —OCH₂CF₃ |
| L-8 | 2 | —OCOC₆H₄O(CH₂)₄OCOCH═CH₂ |
| L-9 | 2 | —OCH═CHC₆H₄OC₅H₁₁(n) |
| L-1O | 2 | —O(CF₂)₃H |

The following will describe a chlorophyllin compound in detail.

The chlorophyllin is preferably a compound represented by the following formula (3):

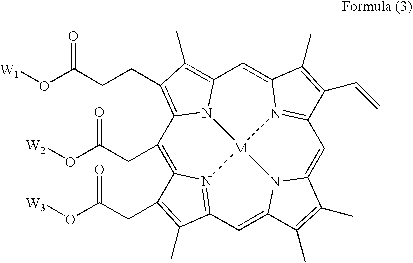

In the formula (3), M represents one metal ion having a complex-forming power and is selected from Fe, Cu, Ni, Al, Mg, V and Co, W₁ to W₃ each independently represents one or more cations selected from a hydrogen ion, an ammonium ion, and an alkali metal ion.

W₁ to W₃ in the metal chlorophyllin derivative represented by the following formula (3) are each a hydrogen ion, an ammonium ion or an alkali metal ion, and are each preferably Na⁺, K⁺, or Li⁺. W₁ to W₃ may each be an independent ion, or may each be present in the form of an alkali metal ion pair.

The complex-forming metal M is preferably Fe, Cu, Ni, Al, V or Co, more preferably Mg, Fe or Cu. It is known that metal chlorophyllin derivatives wherein the complex-forming metal M is Mg naturally exist. Thus, the derivatives are preferred since they are easily available.

The polycondensed aromatic compound having 4 or more rings in the invention exhibits an effect of restraining blocking. Accordingly, the polycondensed aromatic compound having 4 or more rings in the invention may be present in any layer in the thermosensitive transfer ink sheet as long as the layer is present at the thermal transfer layer side of the ink sheet. Examples of this layer will be described later. It is particularly preferred that the sheet contains, in its thermal transfer layer, the compound.

The binder resin containing the polycondensed aromatic compound having 4 or more rings in the invention is preferably a resin used in each of layers on the thermal transfer layer side of the support. The layers will be described later.

The polycondensed aromatic compound specified in the invention is preferably contained in an amount of 0.1 to 10% by mass of the binder resin, more preferably in an amount of 0.2 to 5.0% by mass thereof, most preferably in an amount of 0.5 to 3.0% by mass thereof. If the amount is less than 0.1% by mass, the blocking restraining effect is not sufficiently exhibited. If the amount is more than 10% or more by mass, a problem is caused about the reproducibility of colors. The above-mentioned polycondensed aromatic compounds may be used alone or in combination of two or more thereof. The latter is preferred in some cases.

The following will describe the thermal transfer layer (the dye layer).

(Thermal Transfer Layer)

The thermal transfer layer contains a dye (preferably, a sublimating dye) and a binder resin. If necessary, the layer also contains organic fine particles or inorganic fine particles, a wax, a silicone resin, a fluorine-containing organic compound, and others, which is a preferred aspect of the invention.

The following will describe the dye used in the formation of an image in the invention.

(Dye)

In the thermal transfer layer (which may be referred to briefly as a dye layer hereinafter) of the ink sheet used in the invention, although a known dye that has been hitherto used may be used as a yellow dye, it is preferable to use at least one kind of a dye represented by the following formula (Y1) or (Y2) illustrated below out of such dyes. However, the yellow dye used in the invention is not limited to such dyes.

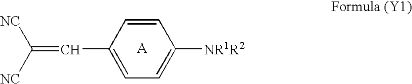

In the formula (Y1), ring A represents a substituted or unsubstituted benzene ring, and each of R¹ and R² represents hydrogen atom, a substituted or unsubstituted alkyl group, a substituted or unsubstituted alkenyl group, or a substituted or unsubstituted aryl group, independently.

Each group of R¹ and R² may further include a substituent. Preferred examples of the substituent by which each group of ring A, R¹ and R² may be substituted, include halogen atoms, and an unsaturated alkyl group, a cycloalkyl group, an aryl group, a heterocyclic group, an alk oxy group, an acyloxy group, a carbamoyloxy group, an alkoxycarbonyloxy group, an aryloxycarbonyloxy group, an amino group, an acylamino group, an aminocarbonylamino group, an alkoxycarbonylamino group, a sulfamoylamino group, an alkyl or arylsulfonylamino group, an alkylthio group, a sulfamoyl group, an alkyl group, an arylsulfinyl group, an arylsulfonyl group, an acyl group, an aryloxycamoyl group, an alkoxycarbonyl group, a carbamoyl group, an aryl or heterocyclic azo group, an imide group, a hydroxyl group, a cyano group, a nitro group, a sulfo group and a carboxyl group.

Preferred examples of the combination of the substituents of a dye represented by the formula (Y1) include a combination wherein ring A is a substituted or unsubstituted benzene ring, R¹ is a substituted or unsubstituted alkyl group having 1 to 8 carbon atom(s), an allyl group or a substituted or unsubstituted aryl group having 6 to 10 carbon atoms, and R² is a substituted or unsubstituted alkyl group having 1 to 8 carbon atom(s), an allyl group, or a substituted or unsubstituted aryl group having 6 to 10 carbon atoms.

More preferred examples of the combination include a combination wherein ring A is a substituted or unsubstituted benzene ring, R¹ is a substituted or unsubstituted alkyl group having 1 to 6 carbon atom(s), an allyl group or a substituted or unsubstituted phenyl group, and R² is a substituted or unsubstituted alkyl group having 1 to 6 carbon atom(s), an allyl group, or a substituted or unsubstituted phenyl group.

Most preferred examples of the combination include a combination wherein ring A is a benzene ring substituted with methyl group, R¹ is an unsubstituted alkyl group having 1 to 4 carbon atom(s), and R² is a substituted alkyl group having 1 to 4 carbon atom(s). If the alkyl group of R² has more substituents, preferable substituents may be an alkoxy group having 1 to 4 carbon(s), an aryl group having 6 to 20 carbons, an aryloxy group having 6 to 20 carbons, an alkoxycarbonyl group having 1 to 4 carbon(s) and a substituted or unsubstituted aryloxycarbonyl group having 6 to 20 carbons.

A detailed example of a yellow dye represented as the formula (Y1) of the invention is illustrated by the following. However, the yellow pigment represented as the formula (Y1), which may be used in the invention, is not limited to the following detailed example.

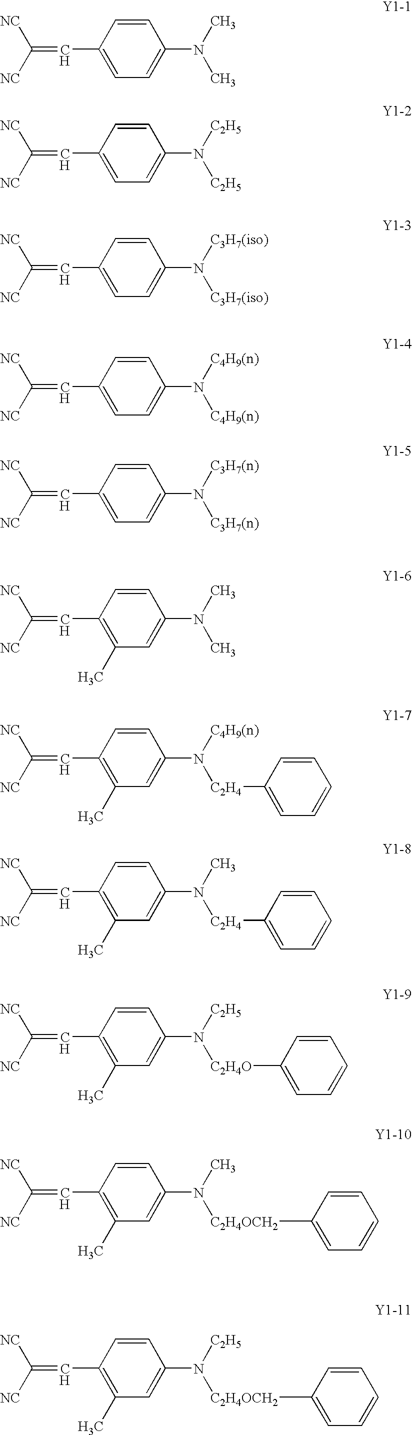

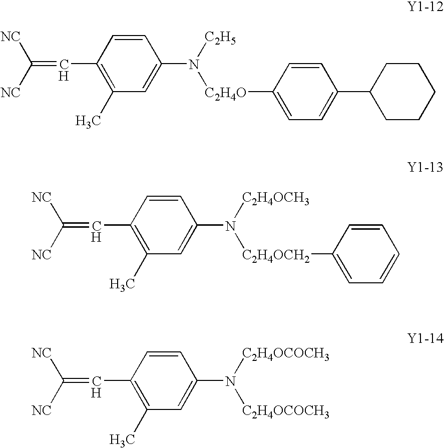

Next, a pigment represented as formula (Y2) is described.

### Formula (Y2)

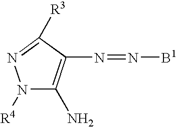

In the formula (Y2), Bl represents a substituted or unsubstituted aryl group, or a substituted or unsubstituted aromatic heterocyclic group, R³ represents a substituted or unsubstituted alkyl group, and R⁴ represents a substituted or unsubstituted alkyl group or a substituted or unsubstituted aryl group.

Each group of R³ and R⁴ may further include a substituent. A preferred substituent with which each group of B¹, R³ and R⁴ may be substituted may be a preferred substituent with which each group of ring A, R¹ and R² may be substituted. A phenyl group which may have a substituent is preferable as an aryl group represented as the B¹.

Preferred examples of the combination of the substituents of a dye represented by the formula (Y2) include a combination wherein B¹ is a substituted or unsubstituted aryl group having 6 to 10 carbons, a substituted or unsubstituted pyrazolyl group, or a substituted or unsubstituted thiadiazolyl group, R³ is a substituted or unsubstituted alkyl group having 1 to 8 carbon(s), and R⁴ is a substituted or unsubstituted alkyl group having 1 to 8 carbon(s), or a substituted or unsubstituted aryl group having 6 to 10 carbons.

More preferred examples of the combination of the substituents include a combination wherein B¹ is a substituted or unsubstituted phenyl group, or a substituted or unsubstituted 1,3,4-thiadiazolyl group, R³ is a substituted or unsubstituted alkyl group having 1 to 6 carbon(s), and R⁴ is a substituted or unsubstituted alkyl group having 1 to 6 carbon(s), or a substituted or unsubstituted phenyl group.

Most preferred examples of the combination of the substituents include a combination wherein B¹ is 4-nitrophenyl group or 1,3,4-thiadiazolyl group substituted with a thioalkyl group having 1 to 6 carbon(s), R³ is an unsubstituted alkyl group having 1 to 4 carbon(s), and R⁴ is an unsubstituted alkyl group having 1 to 4 carbon(s), or a substituted or unsubstituted phenyl group. Preferred substituents for a phenyl group of R⁴ are 2-chloro group, 4-chloro group, 2,4,6-trichloro group, 4-carboxymethyl group, and 4-carboxyethyl group.

A detailed example of a dye represented as the formula (Y2) of the invention is illustrated by the following. However, the invention is not limited thereto.

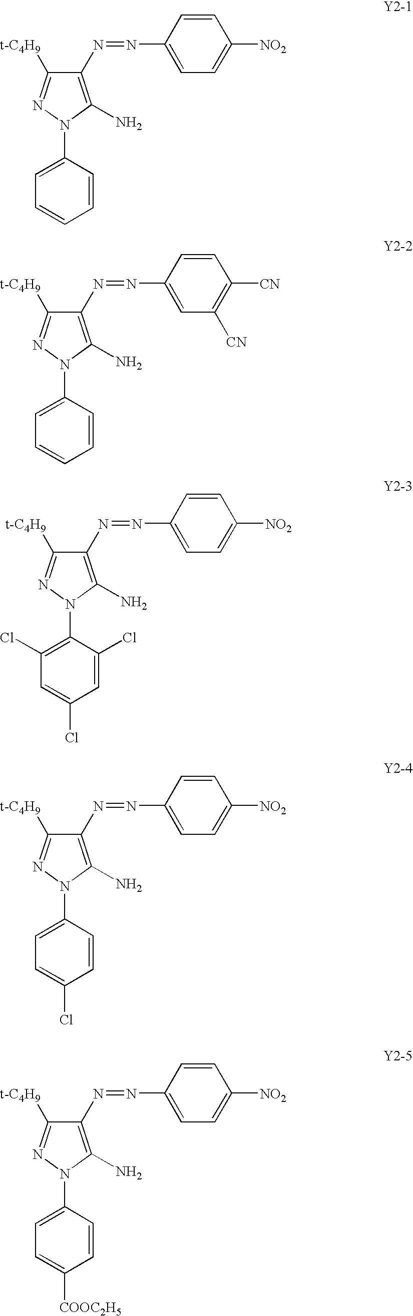

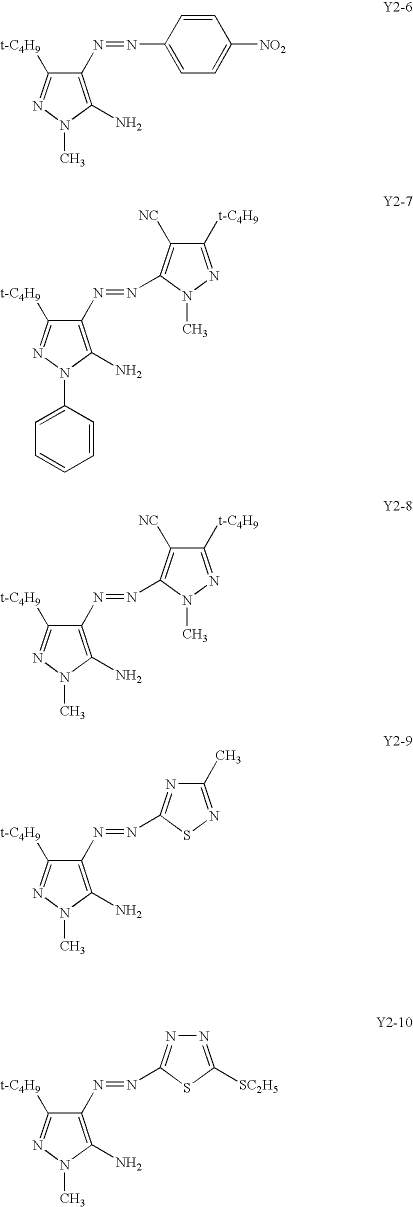

These dyes may be easily synthesized by a method described in Japanese Patent Application Laid-Open (JP-A) No. 1-225592 or a method similar to the method.

In the thermal transfer layer of an ink sheet used in the invention, although a known dye that has been hitherto used may be used as a magenta dye, it is preferable to use at least one kind of a dye represented by formula (M1) or (M2) illustrated below out of such dyes. However, the magenta dye used in the invention is not limited thereto.

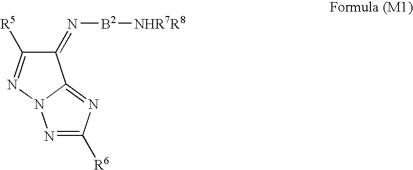

In the formula (M1), B² represents a substituted or unsubstituted phenylene ring or a bivalent substituted or unsubstituted pyridine cyclic group, and each of R⁵, R⁶, R⁷ and R⁸ represents a substituted or unsubstituted alkyl group, a substituted or unsubstituted alkenyl group or a substituted or unsubstituted aryl group, independently.

Each of R⁵, R⁶, R⁷ and R⁸ may further include a substituent. A preferred substituent with which each group of B², R⁵, R⁶, R⁷ and R⁸ may be substituted may be a preferred substituent with which each group of ring A, R¹ and R² of the formula (Y1) may be substituted. 1,4-Phenylene group which may have a substituent is preferable as a phenylene group represented as the B², and a phenylene group which may have a substituent is more preferable than a bivalent pyridine cyclic group as the B².

Preferred examples of the combination of the substituents of a dye represented by the formula (M1) include a combination wherein B² is an unsubstituted phenylene group, R⁵ is a substituted or unsubstituted alkyl group having 1 to 8 carbon(s), or a substituted or unsubstituted aryl group having 6 to 10 carbons, R⁶ is a substituted or unsubstituted alkyl group having 1 to 8 carbon(s), or a substituted or unsubstituted aryl group having 6 to 10 carbons, R⁷ is a substituted or unsubstituted alkyl or allyl group having 1 to 8 carbon(s), and R⁸ is a substituted or unsubstituted alkyl or aryl group having 1 to 8 carbon(s).

More preferred examples of the combination of the substituents include a combination wherein B² is an unsubstituted phenylene group, R⁵ is a substituted or unsubstituted phenyl group, R⁶ is a substituted or unsubstituted alkyl group having 1 to 8 carbon(s), R⁷ is a substituted or unsubstituted alkyl group having 1 to 6 carbon(s), and R⁸ is a substituted or unsubstituted alkyl group having 1 to 6 carbon(s).

Most preferred examples of the combination of the substituents include a combination wherein B² is an unsubstituted phenylene group, R⁵ is 2-chlorophenyl group, R⁶ is a substituted or unsubstituted alkyl group having 1 to 4 carbon(s), R⁷ is a substituted or unsubstituted alkyl group having 1 to 4 carbon(s), and R⁸ is a substituted or unsubstituted alkyl group having 1 to 4 carbon(s). In a case that an alkyl group represented as the R⁸ further includes a substituent, a cyano group is preferable.

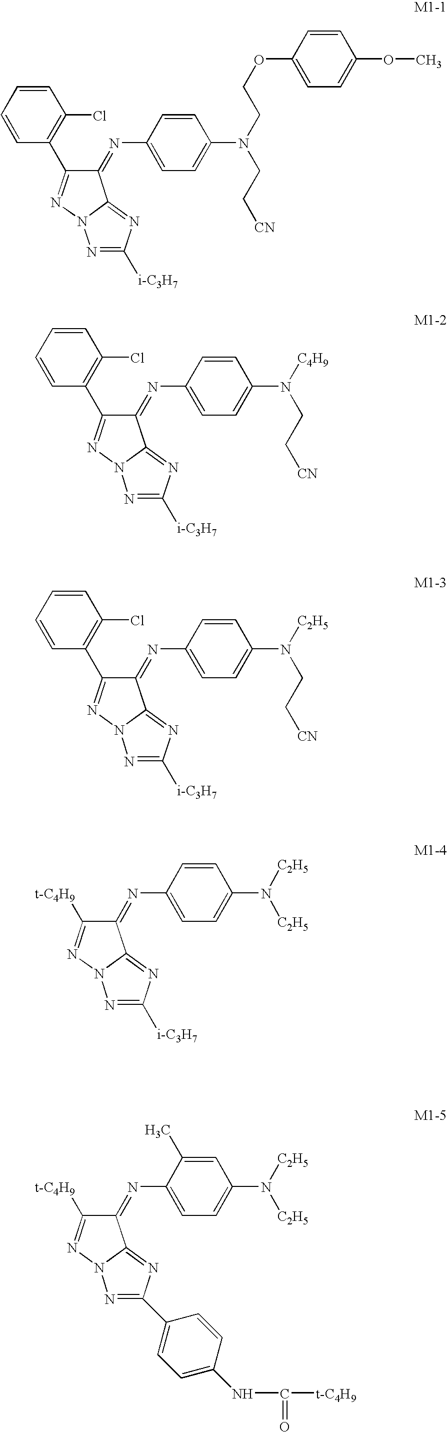

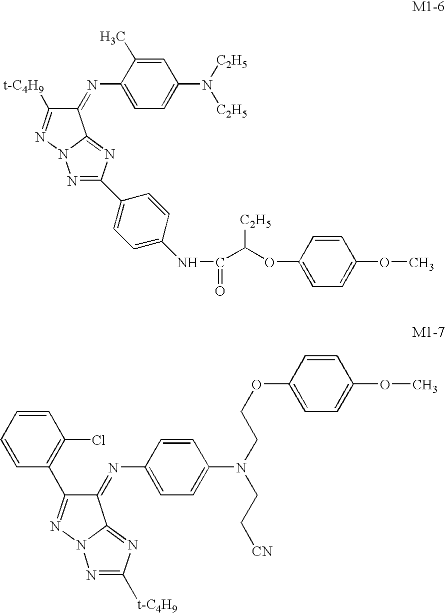

Next, a compound represented as formula (M2) is described in detail.

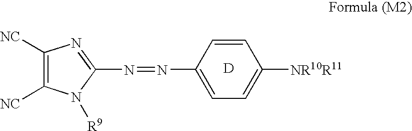

In the formula (M2), ring D represents a substituted or unsubstituted benzene ring and each of R⁹, R¹⁰ and R¹¹ represents a substituted or unsubstituted alkyl group, a substituted or unsubstituted alkenyl group, or a substituted or unsubstituted aryl group, independently. R⁹ also represents hydrogen atom.

Each of R⁹, R¹⁰ and R¹¹ may further include a substituent. A preferred substituent with which each group of ring D, R⁹, R¹⁰ and R¹¹ may be substituted may be a preferred substituent with which each group of ring A, R¹ and R² of the formula (Y1) may be substituted.

Preferred examples of the combination of the substituents of a dye represented by the formula (M2) include a combination wherein ring D is a benzene ring substituted with acylamino group having 2 to 8 carbons, R⁹ is a substituted or unsubstituted alkyl or acyl group having 1 to 8 carbon atom(s), R¹⁰ is a substituted or unsubstituted alkyl or allyl group having 1 to 8 carbon atom(s), and R¹¹ is a substituted or unsubstituted alkyl or ally group having 1 to 8 carbon atom(s).

More preferred examples of the combination of the substituents include a combination wherein ring D is a benzene ring substituted with acylamino group having 2 to 6 carbons, R⁹ is a substituted or unsubstituted alkyl or acyl group having 1 to 6 carbon atom(s), R¹⁰ is a substituted or unsubstituted alkyl or allyl group having 1 to 6 carbon atom(s), and R¹¹ is a substituted or unsubstituted alkyl or ally group having 1 to 6 carbon atom(s).

Most preferred examples of the combination of the substituents include a combination wherein ring D is a benzene ring substituted with acylamino group having 2 to 4 carbons, R⁹ is a substituted or unsubstituted alkyl or acyl group having 1 to 4 carbon atom(s), R¹⁰ is a substituted or unsubstituted alkyl or allyl group having 1 to 4 carbon atom(s), and R¹¹ is a substituted or unsubstituted alkyl or ally group having 1 to 4 carbon atom(s).

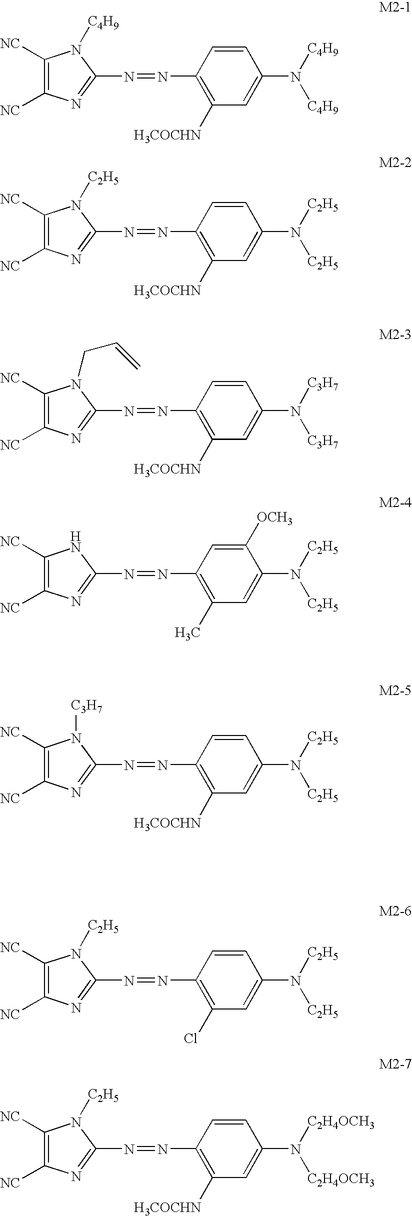

In the thermal transfer layer of an ink sheet used in the invention, although a known dye that has been hitherto used may be used as a cyan dye, it is preferable to use a dye represented by formula (C1) or (C2) illustrated below out of such dyes. However, the cyan dye used in the invention is not limited thereto.

A dye illustrated as the formula (C1) is explained.

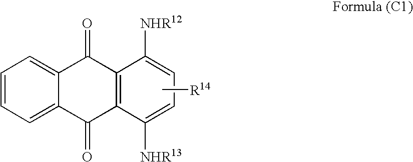

In the formula (C1), each of R¹² and R¹³ represents a substituted or unsubstituted alkyl group, or a substituted or unsubstituted aryl group, independently. R¹⁴ represents hydrogen atom or a substituent.

Each group of R¹² and R¹³ may further include a substituent. A preferred substituent with which each group of R¹² and R¹³ may be substituted may be a preferred substituent with which each group of ring A, R¹ and R² in the formula (Y1) may be substituted. Additionally, a substituent for R¹⁴ may be a preferred substituent with which each group of ring A, R¹ and R² in the formula (Y1) may be substituted.

Preferable examples of a substituent for R¹⁴ may be a halogen atom, an alkyl group, an alkenyl group, an alkynyl group, an aryl group, a heterocyclic group, a cyano group, an alkoxy group, an aryloxy group, acyloxy group, a carbamoyloxy group, an alkoxycarbonyloxy group, an aryloxycarbonyloxy group, an amino group, an acylamino group, an aminocarnoylamino group, an alkoxycarbonylamino group, an aryloxycarbonylamino group, a sulfamoylamino group, an alkyl or aryl sulfonylamino group, an alkylthio group, a sulfamoyl group, an alkyl or aryl sulfinyl group, an alkyl or aryl sulfonyl group, acyl group, an aryloxycarbonyl group, an alkoxycarbonyl group and/or a carbamoyl group (each of these may further include a substituent). More preferable examples of a substituent for R¹⁴ may be hydrogen atom, a halogen atom, an alkyl group, an alkenyl group, an aryl group, a heterocyclic group, an alkoxy group, an aryloxy group, an acyloxy group, a carbamoyloxy group, an alkoxycarbonyloxy group, an aryloxycarbonyoxy group, an amino group, an acylamino group, an aminocarbonylamino group, an alkoxycarbonylamino group, an aryloxycarbonylamino group, an alkylthio group, an acyl group, an aryloxycarbonyl group, an alkoxycarbonyl group and/or a carbamoyl group. Especially, more preferable examples of a substituent for R¹⁴ may be a halogen atom, a substituted or unsubstituted alkyl group having 1 to 4 carbon(s), a substituted or unsubstituted alkenyl group having 2 to 8 carbons, a substituted or unsubstituted aryl group having 6 to 10 carbons, a substituted or unsubstituted heterocyclic group, an alkoxycarbonyl group, and/or an aryloxycarbonyl group. Most preferable examples of a substituent for R¹⁴ may be a substituted or unsubstituted alkyl group having 1 to 4 carbon(s) and/or an alkoxycarbonyl group having 1 to 4 carbon(s).

Preferred examples of the combination of the substituents of a dye represented by the formula (C1) include a combination wherein R¹² is a substituted or unsubstituted alkyl group having 1 to 8 carbon(s), or a substituted or unsubstituted aryl group having 6 to 10 carbons, and R¹³ is a substituted or unsubstituted alkyl group having 1 to 8 carbon(s), or a substituted or unsubstituted aryl group having 6 to 10 carbons.

More preferred examples of the combination of the substituents include a combination wherein R¹² is a substituted or unsubstituted alkyl group having 1 to 6 carbon(s), or a substituted or unsubstituted phenyl group, and R¹³ is a substituted or unsubstituted alkyl group having 1 to 6 carbon(s), or a substituted or unsubstituted phenyl group.

Most preferred examples of the combination of the substituents include a combination wherein

R¹² is a substituted or unsubstituted alkyl group having 1 to 4 carbon(s), and R¹³ is a substituted or unsubstituted alkyl group having 1 to 4 carbon(s), or a substituted or unsubstituted phenyl group.

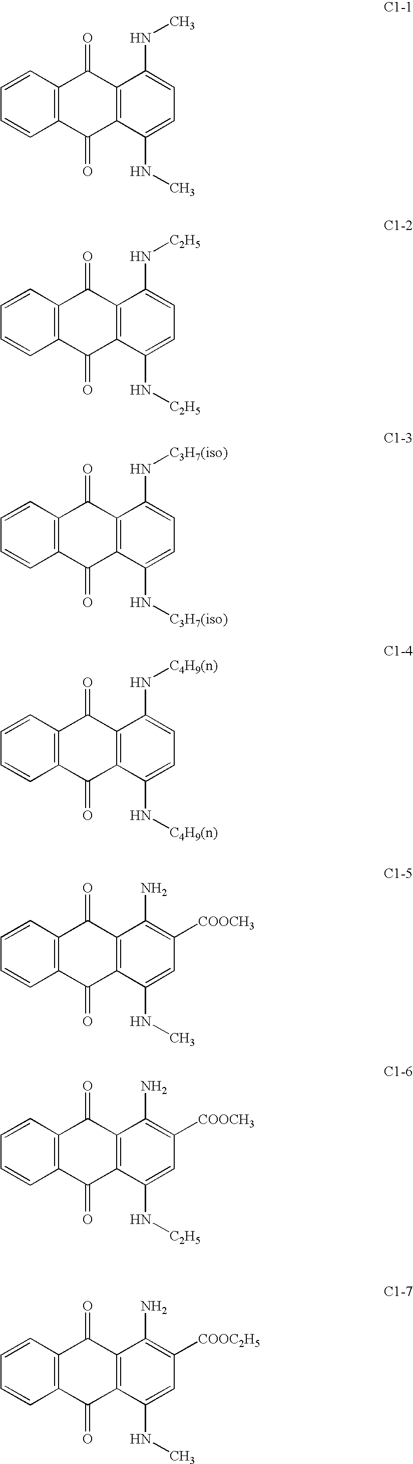

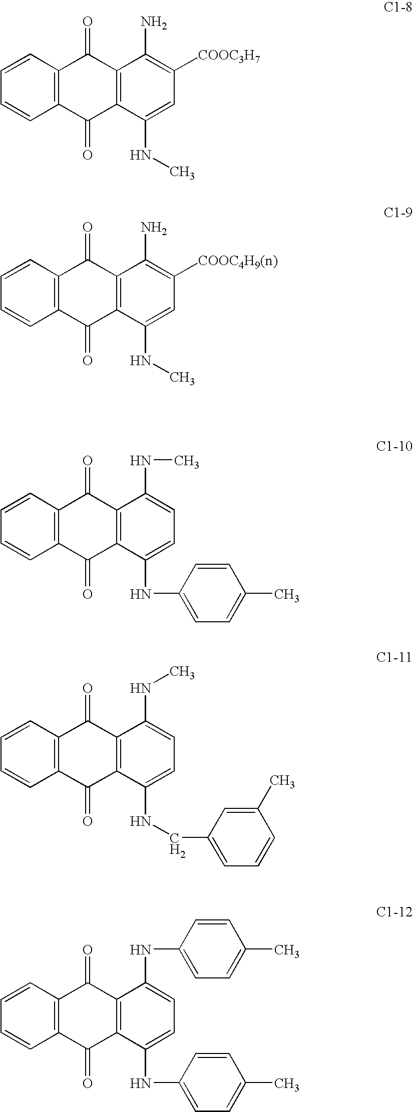

Among the pigments represented by the formula (C1), ones not commercially available can be synthesized in accordance with methods described in U.S. Pat. Nos. 4,757,046 and 3,770,370, DE Patent No. 2316755, JP-A Nos. 2004-51873, 07-137455, and 61-31292, and J. Chem. Soc. Perkin transfer I, 2047 (1977), Champan, “Merocyanine Dye-Doner Element Used in Thermal Dye Transfer”.

Next, a dye represented as formula (C2) is described in detail.

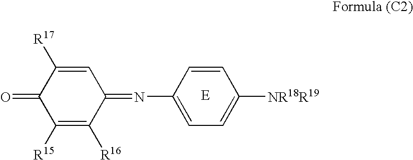

In the formula (C2), ring E represents a substituted or unsubstituted benzene ring, R¹⁵ represents hydrogen atom or a halogen atom, R¹⁶ represents a substituted or unsubstituted alkyl group, R¹⁷ represents a substituted or unsubstituted acylamino group or a substituted or unsubstituted alkoxycarbonylamino group, and each of R¹⁸ and R¹⁹ represents a substituted or unsubstituted alkyl group, a substituted or unsubstituted alkenyl group, or a substituted or unsubstituted aryl group, independently.

Each group of ring E, R¹⁶, R¹⁷, R¹⁸ and R¹⁹ may further include a substituent. A preferred substituent with which each group of ring E, R¹⁶, R¹⁷, R¹⁸ and R¹⁹ may be substituted may be the same as a preferred substituent with which each group of ring A, R¹ and R² of the formula (Y1) may be substituted.

Preferred examples of the combination of the substituents of a dye represented by the formula (C2) include a combination wherein ring E is a benzene ring substituted with an alkyl group having 1 to 4 carbon(s), a benzene ring substituted with chlorine atom, or an unsubstituted benzene ring, R¹⁵ is hydrogen atom, chlorine atom or a bromine atom, R¹⁶ is a substituted or unsubstituted alkyl group having 1 to 8 carbon(s), R¹⁷ is a substituted or unsubstituted acylamino group having 2 to 10 carbons, or a substituted or unsubstituted alkoxycarbonylamino group having 2 to 10 carbons, R¹⁸ is a substituted or unsubstituted alkyl group having 1 to 8 carbon(s), and R¹⁹ is a substituted or unsubstituted alkyl group having 1 to 8 carbon(s).

More preferred examples of the combination of the substituents include a combination wherein ring E is a benzene ring substituted with an alkyl group having 1 to 2 carbon(s), or an unsubstituted benzene ring, R¹⁵ is hydrogen atom or chlorine atom, R⁶ is a substituted or unsubstituted alkyl group having 1 to 6 carbon(s), R¹⁷ is a substituted or unsubstituted acylamino group having 2 to 8 carbons, or a substituted or unsubstituted alkoxycarbonylamino group having 2 to 8 carbons, R¹⁸ is a substituted or unsubstituted alkyl group having 1 to 6 carbon(s), and R¹⁹ is a substituted or unsubstituted alkyl group having 1 to 6 carbon(s).

Most preferred examples of the combination of the substituents include a combination wherein ring E is a benzene ring substituted with methyl group or an unsubstituted benzene ring, R¹⁵ is hydrogen atom or chlorine atom, R¹⁶ is a substituted or unsubstituted alkyl group having 1 to 6 carbon(s), R¹⁷ is a substituted or unsubstituted acylamino group having 2 to 6 carbons, or a substituted or unsubstituted alkoxycarbonylamino group having 2 to 6 carbons, R¹⁸ is a substituted or unsubstituted alkyl group having 1 to 4 carbon(s), and R¹⁹ is a substituted or unsubstituted alkyl group having 1 to 4 carbon(s).

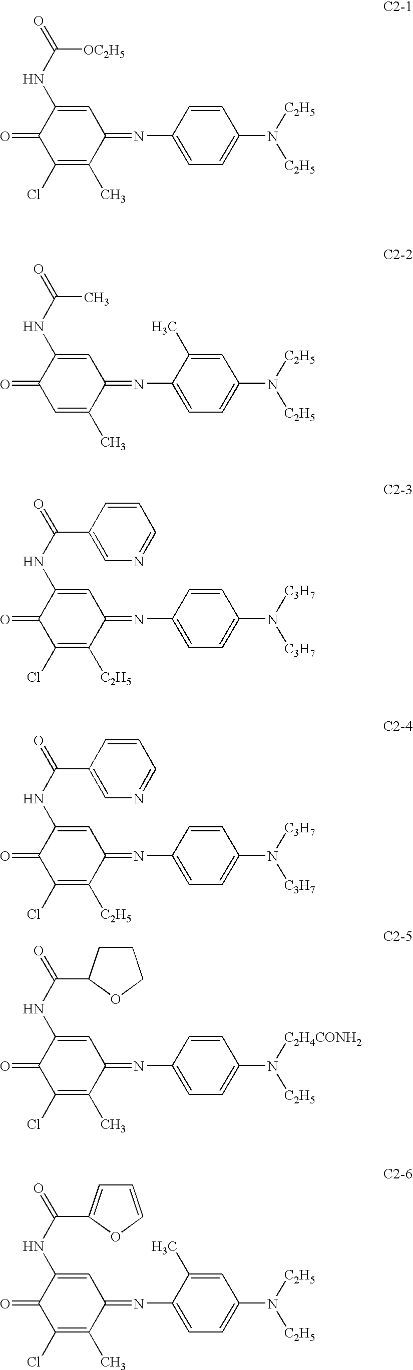

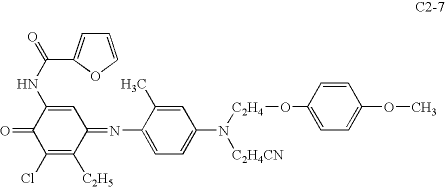

As the binder resin contained in the thermal transfer layer in the prior art in order to carry a dye as described above, various binders are known. In the invention also, these may be used. Examples thereof include modified celluloses such as ethylcellulose, hydroxyethylcellulose, ethylhydroxycellulose, hydroxypropylcellulose, ethylhydroxyethylcellulose, methylcellulose, cellulose acetate, cellulose acetate butyrate, cellulose acetate propionate and cellulose nitrate, vinyl resins such as polyvinyl alcohol, polyvinyl acetate, polyvinyl butyral, polyvinyl acetal, polyvinyl pyrrolidone, polystyrene and polyvinyl chloride, acrylic resins such as polyacrylonitrile, polyacrylic ester and polyacrylamide, polyurethane resin, polyamide resin, polyester resin, polycarbonate resin, phenoxy resin, phenolic resin, epoxy resin, and various elastomer resins. These can each be preferably used. These may be used alone or in a mixture form. When the binder is a polymer, it is allowable to copolymerize two or more constituting monomers of the above-mentioned examples with each other and use the resultant. A binder wherein a resin as described above is crosslinked with one or more out of various crosslinking agents is also preferred.

In particular, a modified cellulose resin, or a vinyl resin is preferably used, and a propionic acid modified cellulose, polyvinyl butyral or polyvinyl acetal is more preferably used.

The above-mentioned sublimating dye and binder resin are dissolved or dispersed in a solvent to prepare a dye ink. The solvent used at this time may be selected from various known solvents. Examples thereof include alcohol solvents such as methanol, ethanol, isopropyl alcohol, butanol, and isobutanol; ketone solvents such as methyl ethyl ketone, methyl isobutyl ketone, and cyclohexanone; aromatic solvents such as toluene, and xylene; and water. These solvents may be used alone or in the form of a mixture.

Besides the dye, the binder and the essential compound in the invention, various additives may be added to the dye layer in order to improve the storability, the runnability in a printer, the releasability after an image is printed, and various other properties. Typical preferred examples of the additives include organic or inorganic fine particles, and waxes.

The organic fine particles are preferably made of, for example, a polyolefin resin such as polyethylene or polypropylene, fluorine-contained resin, a polyamide resin such as or nylon resin, urethane resin, styrene/acrylic crosslinked resin, phenol resin, urea resin, melamine resin, polyimide resin, or benzoguanamine resin, and are more preferably made of polyethylene. The inorganic fine particles are preferably made of, for example, calcium carbonate, silica, clay, talc, titanium oxide, magnesium hydroxide, or zinc oxide.

The organic or inorganic fine particles are contained preferably in an amount of 0.5 to 5% by mass of the binder resin in the thermal transfer layer.

In a preferred aspect of the invention, a wax is incorporated into the thermal transfer layer besides the above-mentioned sublimating dye, binder resin and organic or inorganic fine particles. Preferred examples of the wax that may be used include waxes which originate from petroleum, such as microcrystalline wax and paraffin wax, waxes which originate from mineral, such as montan wax, waxes which originate from a plant, such as carnauba wax, tallow and candelilla wax, waxes which originate from an animal, such as beeswax, spermaceti, insect wax and shellac wax, synthetic waxes, such as Fischer-Tropsch wax, various low molecular weight polyethylenes, aliphatic acid ester, aliphatic acid amide and silicone wax, and partially modified waxes.

In a different preferred aspect, a resin is also incorporated into the thermal transfer layer, examples of the resin including silicone resin, fluorine contained resin, acrylic resin, cellulose resin, vinyl chloride/vinyl acetate copolymer, and cellulose nitride. Such wax and resin may be incorporated in an amount of 0.1 to 10% by mass, preferably 1 to 3% by mass of all solids in the formed thermal transfer layer.

The following will describe the structure of the thermal transfer ink sheet of the invention.

The thermal transfer ink sheet of the invention is a thermal transfer ink sheet having a support having, over one surface thereof, at least one thermal transfer layer. This thermal transfer layer is a layer formed by painting a coating-solution containing the dye and the resin in the above-mentioned item “Thermal Transfer Layer”.

(Support)

The above-mentioned support may be any support known in the prior art as long as the support has required heat resistance and strength. Specifically, the support is, for example, a thin sheet made of glassine paper, condenser paper or paraffin paper; a drawn or non-drawn film made of a plastic, for example, a highly heat-resistant polyester such as polyethylene terephthalate, polyethylene naphthalete, polybutylene terephthalate, polyphenylene sulfide, polyetherketone or polyethersulfone, polypropylene, polycarbonate, cellulose acetate, a polyethylene derivative, polyvinyl chloride, polyvinylidene chloride, polystyrene, polyamide, polyimide, polymethylpentene, or ionomer; or a laminate made of such sheets or films. Out of these supports, a polyester film is particularly preferred. A polyester film subjected to drawing treatment is most preferred. The thickness of the support may be appropriately selected in accordance with the material thereof so as to make the strength, the heat resistance or the like appropriate. The thickness is preferably from about 1 to 100 μm, more preferably from about 2 to 50 μm, even more preferably from about 3 to 10 μm.

In the thermosensitive transfer recording process in a sublimating manner, it is necessary to transfer only dyes having individual color tones, which are contained in the thermosensitive transfer ink sheet, when an image is printed, and it is not preferred to transfer the resin in which the dyes are carried. It is therefore necessary that the adhesion between the thermal transfer layer and the support of the thermosensitive transfer ink sheet is strong. If the adhesion is weak, the thermal transfer layer itself adheres to an image-receiving sheet, so that the image quality of the resultant print may be damaged.

However, in the case of the above-mentioned polyester film, which is a preferred example of the support, it cannot be said that the wettability of inks (i.e., dye-containing coating-solutions) having color tones, which will be detailed later, onto the film is good. Thus, the adhesive force of the film to the dyes may be insufficient. Against this problem, it is preferred to use a method of treating the support surface in a physical manner, and/or a method of forming an easily dye-bondable layer on the support surface.

Preferably, an easily dye-bondable layer made of a resin is formed on the support, and then the dye layer is formed thereon. In order to form the easily dye-bondable layer, urethane resin, polyester resin, polypropylene resin, polyol resin, acrylic resin, a reaction product made from such a resin and an isocyanate compound, or the like may be used. The isocyanate compound may be, for example, a diisocyanate compound or triisocyanate compound that has been hitherto used. The applied amount of the dye layer is preferably from 0.05 to 0.1 g/m².

When the thermosensitive transfer ink sheet is formed, it is allowable to use a support on which an easily dye-bondable layer is beforehand formed, and form a thermal transfer layer thereon.

(Thermal Transfer Layer Forming Method)

The thermal transfer layer in the invention is formed by applying a coating-solution (ink) for the thermal transfer layer onto a support by gravure printing or some other layer-forming method, and drying the formed wet-layer. The ink for the dye layer is a product wherein a sublimating dye, a binder resin, and optional additives such as organic or inorganic fine particles and a wax are dissolved or dispersed in an appropriate solvent.

The applied amount of the thermal transfer layer is preferably from about 0.2 to 5 g/m², more preferably from about 0.4 to 2 g/m² in the state that the layer is dry. The content by percentage of the sublimating dye in the thermal transfer layer is preferably from 5 to 90% by mass, more preferably from about 10 to 70% by mass.

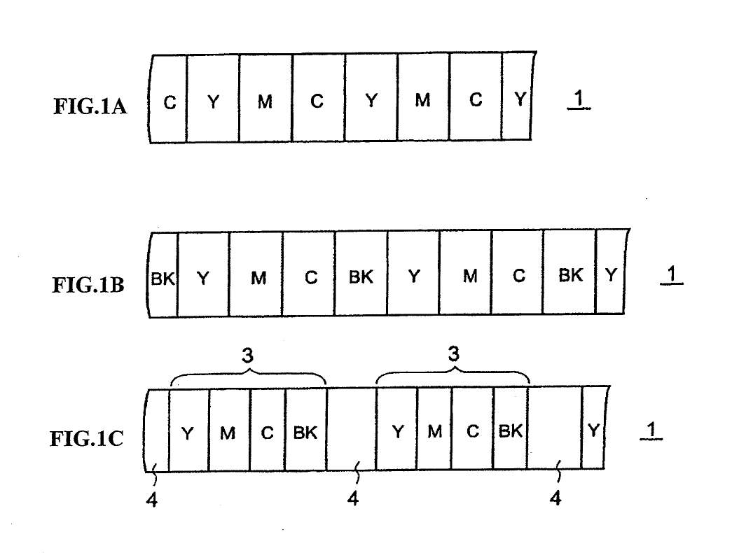

Embodiments of the thermosensitive transfer ink sheet of the invention are illustrated in FIGS. 1 to 3. Each reference number 1 represents a thermosensitive transfer ink sheet, each reference number 3 represents an ink layer or dye layer, and each reference number 4 represents a transferable protecting layer laminate.

The thermosensitive transfer ink sheet of the invention is a sheet wherein a dye layer, which is a thermal transfer layer in at least one color, is formed. In general, according to the thermal transfer ink sheet, print is made in order of yellow, magenta and cyan. Thus, as illustrated in FIG. 1A, it is preferred that dye layers C, M and Y, which have the different colors tones, are successively formed on a single support in the longitudinal direction thereof. As illustrated in FIG. 1B, a black layer BK may be formed. Furthermore, a transferable protecting layer laminate, which will be detailed later, may be formed. However, the arrangement of the dye layers, which are thermal transfer layers having different color tones, in the invention is not limited to the above. As the need arises, the layers may be arbitrarily arranged.

The peelability of the thermosensitive transfer ink sheet and an image-receiving sheet from each other, or some other property is changed by the order that colored images are printed; thus, a preferred aspect is an aspect wherein in accordance with this order, the amounts of additives added to the respective dye layers are varied dependently on the layers. For example, in a dye layer which is to be later transferred for print out of the dye layers, the amount of a releasing agent contained in this dye layer may be made larger.

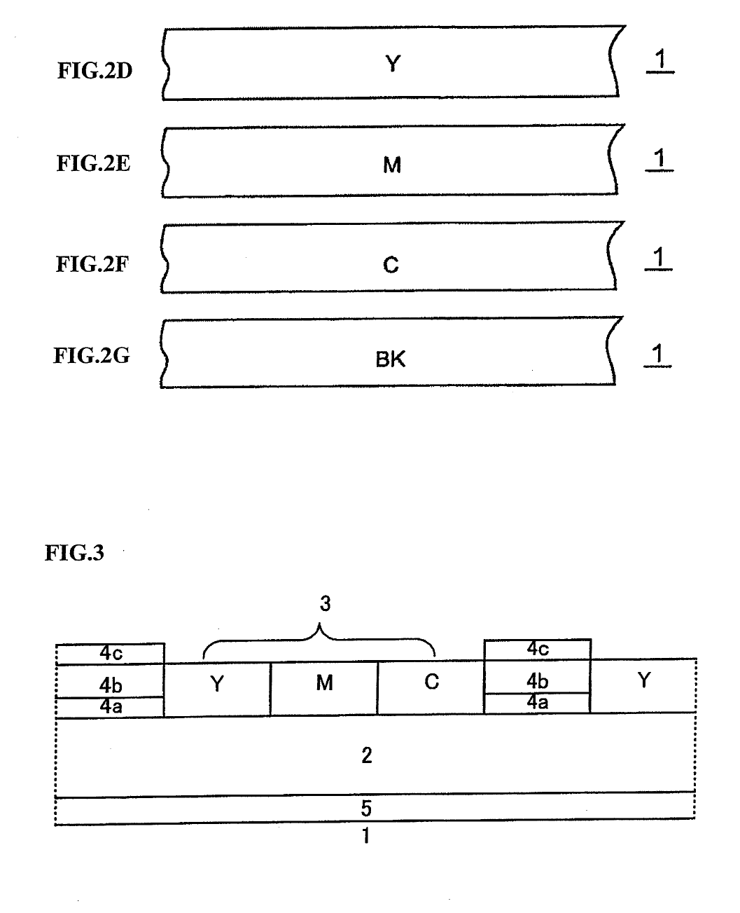

As illustrated in FIGS. 2D to 2G, dye layers having different color tones may be formed on different supports, respectively, instead of the formation of layers having different color tones on a single support.

In the thermosensitive transfer ink sheet of the invention, a dye layer thereof may have a monolayer structure, or a multilayer structure, which has two or more layers. Additionally, out of dye layers of each color, a monolayer structure and a multilayer structure may be mixed. An example of such a case is illustrated in FIG. 3. A yellow dye layer Y, a magenta dye layer M and a cyan dye layer C have a monolayer structure. In a case that the dye layer is a multilayer structure, a polycondensed aromatic compound used in the invention is contained at least in one layer out of multiple dye layers. Preferably, the polycondensed aromatic compound is contained in a dye layer which is farthest from a support, and most preferably, the polycondensed aromatic compound is contained only in a dye layer which is farthest from a support.

The applied amount of the whole of the dye layer having a multilayer structure is preferably from about 0.2 to 5 g/m², more preferably from about 0.4 to 2 g/m². The thickness of each of layers which constitute the dye layer is decided to set the amount of the layer preferably into the range of about 0.2 to 2 g/m². The amount of the sublimating dye contained in the whole of the dye layer is from 5 to 90% by mass, preferably from 10 to 70% by mass.

(Transferable Protecting Layer Laminate)

In the invention, it is also preferred to form a transferable protecting layer laminate in the thermal transfer ink sheet. The transferable protecting layer laminate is a laminate for forming a protecting layer made of a transparent resin on a thermally transferred image by thermal transfer, so as to cover and protect the image. The laminate is used to improve the endurances of the image, such as the scratch resistance, the light resistance, and the weather resistance thereof. In the state that the dye(s) transferred onto the image-receiving sheet is/are present in the surface of the sheet, the image endurances, such as the scratch resistance, the light resistance and the weather resistance, may be insufficient. Thus, it is preferred to form such a transparent protecting layer. As illustrated in FIG. 3, on a support, a releasing layer 4a, which is nearest to the support, a protecting layer 4b and an adhesive layer 4c may be successively formed. The protecting layer may be made of plural layers. When the protecting layer also has the function of the different layer(s), the releasing layer and/or the adhesive layer may be omitted. The used support may be a support on which an easily dye-bondable layer is formed.

The resin which constitutes the protecting layer is preferably a resin excellent in scratch resistance, chemical resistance, transparency and hardness. Examples thereof include polyester resin, polystyrene resin, acrylic resin, polyurethane resin, and acrylic urethane resin; silicon modified resins of these resins; mixtures of two or more of these resins: ionizing radiation curable resins; and ultraviolet blocking resins. Besides, various resins that have been known as a protecting layer forming resin in the prior art may be used. It is also preferred to appropriately add, to the protecting layer, for example, an ultraviolet absorber, an antioxidant, a fluorescent whitening agent, an organic filler and/or an inorganic filler if necessary in order to attain the supply of ultraviolet absorbency, an improvement in the layer-(or film-)releasability when an image is transferred, the gloss and the whiteness of the image-receiving sheet, and other purposes.

The acrylic resin in the invention is preferably a polymer made from one or more monomers selected from acrylic monomers and methacrylate monomers known in the prior art. The monomer(s) may be copolymerized with styrene, acrylonitrile or the like. A preferred example of the monomer(s) is methyl methacrylate, which is preferably charged into the starting monomers at a ratio of 50% or more by mass of the whole of the starting monomers.

The polyester resin in the invention may be a saturated polyester resin known in the prior art. Examples of the acid component of this polyester resin include aromatic acids such as terephthalic acid, isophthalic acid, orthophthalic acid, 2,6-naphthalenedicarboxylic acid, tetrahydrophthalic acid, hexahydrophthalic acid, hexahydroisophthalic acid, and hexahydroterephthalic acid; and aliphatic dicarboxylic acids such as succinic acid, adipic acid, azelaic acid, sebacic acid, dodecadioic acid, and dimer acid; and alicyclic dicarboxylic acids such as cyclohexanedicarboxylic acid, tricyclodecanedicarboxylic acid, and decalindicarboxylic acid. These compounds may each be methyl-esterified. An acid anhydride of each of the compounds may be used.

If necessary, the following may be used together: p-(hydroxyethoxy)benzoic acid, hydroxypivalic acid, γ-butyrolactone, ε-caprolactone, fumaric acid, maleic acid, maleic anhydride, itaconic acid, citraconic acid, or the like. Moreover, if necessary, a polycarboxylic acid having three or more function groups, such a tri- or tetra-carboxylic acid, for example, trimellitic acid or pyromellitic acid, may be used in an amount of 10% or less by mole of all carboxylic acid components. Particularly preferred is a structure containing, in the chain of a single molecule, one or more acid components wherein an aromatic dicarboxylic acid is partially substituted with a sulfonic acid or a salt thereof. It is more preferred that the upper limit of the amount of the substituted sulfonic acid (or the group of the salt thereof) is decided in such a manner that this acid component is copolymerized so as to make the resultant product soluble in an organic solvent since a different additive or resin soluble in the organic solvent can be used in the form of a mixture with the product. Preferred examples of the aromatic dicarboxylic acid containing the substituted sulfonic acid (or the group of the salt thereof) include sulfoterephthalic acid, 5-sulfoisophthalic acid, 4-sulfophthalic acid, 4-sulfonaphthalene-2,7-dicarboxylic acid, and 5-(4-sulfophenoxy)isophthalic acid; and ammonium salts thereof, and metal salts (such as lithium, potassium, magnesium, calcium, copper, and iron salts) thereof. Particularly preferred is sodium 5-sulfoisophtalic acid.

Examples of the polyol component that is the other of the starting materials of the polyester used in the invention include ethylene glycol, 1,2-propylene glycol, 1,3-propanediol, 1,4-butanediol, neopentyl glycol, 1,5-pentanediol, 1,6-hexanediol, 3-methyl-1,5-pentanediol, 1,9-nonanediol, 2-ethyl-2-butylpropanediol, neopentyl glycol ester of hydroxypivalic acid, dimethylolheptane, and 2,2,4-trimethyl-1,3-pentanediol. If necessary, the following may also be used: diethylene glycol, triethylene glycol, dipropylene glycol, polyethylene glycol, polypropylene glycol, polytetramethylene glycol, a neopentyl glycol ethylene oxide adduct, or a neopentyl glycol propylene oxide adduct.

Examples of the aromatic-moiety-containing glycol include p-xylene glycol, m-xylene glycol, o-xylene glycol, 1,4-phenylene glycol, an ethylene oxide adduct of 1,4-phenylene glycol, bisphenol A, and glycols each obtained by adding one mole to several moles of ethylene oxide or propylene oxide to two phenolic hydroxyl groups of a bisphenol, such as an ethylene oxide adduct of bisphenol A and a propylene oxide adduct thereof. Examples of the aliphatic diol component include tricyclodecandiol, tricyclodecanedimethylol, tricyclodecanedimethanol (TCD-M), cyclohexanediol, 1,4-cyclohexanedimethanol, hydrogenated bisphenol A, and an ethylene oxide or propylene oxide adduct of hydrogenated bisphenol A. The polyester resin preferably has a glass transition temperature of 50 to 120° C. The molecular weight thereof is preferably from 2,000 to 40,000, more preferably 4,000 to 20,000 since the protecting layer is satisfactorily released from the base thereof when this layer is transferred.

When an ionizing radiation curable resin is used, a protecting layer particularly good in plasticizer resistance and scratch resistance can be obtained. Specific examples thereof include a radical-polymerizable polymer or oligomer which can be crosslinked or cured by ionizing radiation. If necessary, at this time, the polymer or oligomer may be crosslinked or cured by an electron beam or ultraviolet rays in the state that a photopolymerization initiator may be added thereto. Besides, a known ionizing radiation curable resin may be used.

Another preferred aspect of the protecting layer is a protecting layer containing one or more ultraviolet absorbents and/or an ultraviolet blocking resin in order to give light resistance to a printed matter.

About the ultraviolet absorbent(s), it is preferred to use a combination of different absorbents in order to cover an effective ultraviolet absorption wavelength range in accordance with the dye(s) used to form an image. About non-reactive ultraviolet absorbents, it is preferred to use a mixture of ones having different structures so as not to precipitate the ultraviolet absorbents.

Examples of the organic filler and/or the inorganic filler include polyethylene wax, bisamide, nylon, acrylic resin, crosslinked polystyrene, silicone resin, silicone rubber, talc, calcium carbonate, titanium oxide, alumina, silica particles such as microsilica and colloidal silica. The filler(s) is/are not limited thereto in the thermal transfer sheet of the invention, and known fillers can be preferably used.

The organic filler and/or the inorganic filler is/are a filler or fillers having a particle diameter of 10 μm or less, preferably 0.1 μm to 3 μm, and having a good lubricity and a high transparency. The added amount of the filler(s) is preferably such an amount that the transparency of the protecting layer is kept at the time of transferring the layer. Specifically, the amount is preferably from 0 to 100 parts by mass for 100 parts by mass of the resin.

The protecting layer is formed by a method similar to the method for forming the thermal transfer layer, and preferably has a thickness of about 0.5 to 10 μm provided that the method and the thickness depend on the kind of

(Releasing Layer)

In the case that the protecting layer is not easily peeled from the support when the layer is transferred, a releasing layer 4a is preferably formed between the support and the protecting layer. The releasing layer can be formed by: painting a coating-solution containing a material good in releasability (such as silicone wax, some other wax, silicone resin, or fluorine-contained resin), or a resin having a relatively high softening point, which is not melted by heat from a thermal head (such as cellulose resin, acrylic resin, polyurethane resin, polyvinyl acetal resin, acryl vinyl ether resin, maleic anhydride resin, silicone resin, fluorine-contained resin, or a resin obtained by incorporating, into such a resin, a thermal releasing agent such as a wax) by a coating process known in the prior art (such as gravure coating or gravure reverse coating); and then drying the resultant. Out of the above-mentioned resins, preferred is acrylic resin, which is made from acrylic acid only or methacrylic acid only, or which is made by copolymerizing such an acid with a different monomer or the like. Acrylic acid is good in adhesion to the support, and releasability from the protecting layer. The above-mentioned resins may be used alone or in combination of two or more thereof. The releasing layer remains on the side of the support after an image is formed (the dye is transferred).

The thickness of the layer is preferably from 0.5 to 5 μm. Various particles may be incorporated into the releasing layer or the protecting layer side surface of the releasing layer may be subjected to matting treatment so as to make the surface into a mat state, thereby making the image-receiving sheet surface into a mat state after an image is printed on the surface.

A peeling layer may be formed between the transferable protecting layer and the releasing layer. The peeling layer is transferred together with the protecting layer. After the transferring, the peeling layer is a topmost layer of the image-receiving sheet on which the image is printed, and is made of a resin excellent in transparency, abrasion resistance, and chemical resistance. Examples of the resin include acrylic resin, epoxy resin, polyester resin, and styrene resin. A filter, a wax or the like may be added to the layer.

(Adhesive Layer)

It is preferred to form an adhesive layer, as a topmost layer of the transferable protecting layer laminate, on the protecting layer. This makes it possible to make the transferability of the protecting layer good. For the adhesive layer, a known adhesive, thermosensitive adhesive, or thermoplastic resin may be used. Examples thereof include polyester resin, vinyl chloride/vinyl acetate copolymer resin, acrylic resin, acrylic component/ultraviolet absorbent copolymer resin, ultraviolet absorptive resin, butyral resin, epoxy resin, polyamide resin, polyvinyl chloride resin, polycarbonate resin, and other resins good in adhesiveness when heated. Out of these resins, thermoplastic resin having a glass transition temperature (Tg) of 40 to 80° C. is preferred.

If the Tg is lower than 40° C., the adhesiveness between the covered image and the transparent protecting layer is liable to be insufficient. If the Tg is higher than 80° C., the transferability of the transparent protecting layer is liable to be insufficient.

Particularly preferred are polyvinyl chloride resin, polyvinyl acetate resin, and vinyl chloride/vinyl acetate copolymer resin having a polymerization degree of 50 to 300, preferably 50 to 250.

The ultraviolet absorptive resin may be, for example, a resin yielded by causing a reactive ultraviolet absorbent to react and bond with a thermoplastic resin or ionizing radiation curable resin.

The above-mentioned ultraviolet absorbent may be added to the adhesive layer. If necessary, additives may be appropriately used, examples of the additives including a colored pigment, a white pigment, an extender pigment, an antistatic agent, a filler, an antioxidant, and a fluorescent whitening agent. The adhesive layer is formed by painting a coating-solution containing an adhesive-layer-constituting resin as described resin and optionally containing additives as described above, and then drying the resultant wet layer. The thickness of the adhesive layer is preferably from about 0.5 to 10 μm, more preferably from 0.5 to 5 μm, even more preferably from 0.5 to 3 μm when the layer is in a dry state.

(Ultraviolet Absorbent)

The ultraviolet absorbent preferably has an absorption region in the ultraviolet range, ends of the region being not in the visible range. Specifically, when the ultraviolet absorbent is added to a predetermined layer to form a thermosensitive transfer ink sheet (or a thermosensitive transfer image-receiving sheet), the absorbent is preferably an ultraviolet absorbent having a maximum absorption in the range of 330 to 370 nm, the absorption density Abs in the range being 0.8 or more. The absorption density Abs at 380 nm is preferably 0.5 or more. The absorption density Abs at 400 nm is preferably 0.1 or less. If the absorption density is high in the range of more than 400 nm, the resultant image unfavorably becomes yellowish.

Such an ultraviolet absorbent may be an inorganic ultraviolet absorbent or organic ultraviolet absorbent known in the prior art. The organic ultraviolet absorbent may be a non-reactive ultraviolet absorbent such as a salicylate, benzophenone, benzotriazole, triazine, substituted acrylonitrile, nickel chelate or hindered amine absorbent; or an ultraviolet blocking resin obtained by introducing, into such a non-reactive ultraviolet absorbent, for example, an addition-polymerizable double bond in vinyl, acryloyl, methacryloyl or the like, or an alcoholic hydroxyl, amino, carboxyl, epoxy or isocyanate group, and then copolymerizing the resultant with a thermoplastic resin, such as acrylic resin, or grafting the resultant to a thermoplastic resin. Out of these ultraviolet absorbents, preferred are organic ultraviolet absorbents which will be described later, in particular, benzophenone, benzotriazole and triazine absorbents.

Additionally, disclosed is a method of yielding an ultraviolet blocking resin by dissolving an ultraviolet absorbent into a monomer or oligomer for the resin used in the protecting layer, and then polymerizing the monomer or oligomer (JP-A No. 2006-21333). In this case, the ultraviolet absorbent may be a non-reactive absorbent.

Examples of commercially available products of the ultraviolet absorbent include TINUVINE [transliteration] P (manufactured by Ciba Geigy), JF-77 (manufactured by Johoku Chemical Co., Ltd.), SEASOAP [transliteration] 701 (manufactured by Shiraishi Calcium Kaisha, Ltd.), SUMISOAP [transliteration] 200 (manufactured by Sumitomo Chemical Co., Ltd.), BIOSOAP [transliteration] 520 (manufactured by Kyodo Chemical Co., Ltd.), and ADECASTAB [transliteration] LA-32 (manufactured by Asahi Denka Kogyo K.K.).

In the invention, the ultraviolet absorbent may be a polymerized absorbent. In this case, the mass average molecular weight is preferably 10000 or more, more preferably 100000 or more. The manner for the polymerization is preferably a manner of grafting an ultraviolet absorbent to a polymer. The polymer, which becomes a main chain, preferably has a polymer skeleton poorer in dyeability than the image-receiving polymer used together. Moreover, the polymer preferably has a sufficient film-strength when the polymer is formed into a film. The graft ratio of the ultraviolet absorbent to the polymer chain is preferably from 5 to 20% by mass, more preferably from 8 to 15% by mass.

The polymer containing a unit having ultraviolet absorptivity (ultraviolet absorbent unit) may be converted in a latex form. In this case, by the conversion, a water-dispersive coating-solution can be formed into an image-receiving layer by painting. As a result, costs for the production can be decreased. The method for the conversion into a latex form may be a method described in, for example, Japanese Patent No. 3450339. The ultraviolet absorbent in a latex form may be a commercially available ultraviolet absorbent manufactured by Ipposha Oil Industries Co., Ltd. (trade name: ULS-700, ULS-1700, ULS-1383MA, ULS-1635 MH, XL-7016, ULS-933LP, or ULS-935LH, and that manufactured by Shin-Nakamura Chemical Co., Ltd. (trade name: New Coat UVA-1025W, New Coat UVA-204W, or New Coat UVA-4512M), or the like.

When the polymer containing a unit having ultraviolet absorptivity is converted into a latex form, an image-receiving layer wherein an ultraviolet absorbent is evenly dispersed can be formed by converting the above-mentioned dyeable image-receiving polymer into a latex form in the same manner, mixing the two, and then painting the mixture.

The added amount of the polymer containing a unit having ultraviolet absorptivity or the latex thereof is preferably from 5 to 50 parts by mass, more preferably form 10 to 30 parts by mass for 100 parts by weight of the dyeable image-receiving polymer, which forms the image-receiving layer, or the latex thereof.

The ultraviolet absorbent may be an organic compound or an inorganic compound. In the case of the organic ultraviolet absorbent, preferred examples of the absorbent are compounds represented by the following formulae (U1) to (U8).

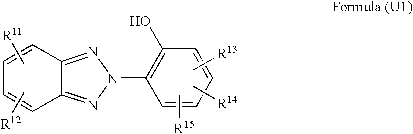

In the formula, R¹¹, R¹², R¹³, R¹⁴ and R¹⁵ each independently represents a hydrogen or halogen atom, or the following group: alkyl, which may be cycloalkyl or bicycloalkyl, alkenyl, which may be cycloalkenyl or bicycloalkenyl, alkynyl, aryl, heterocyclic, cyano, hydroxyl, nitro, carboxyl, alkoxy, aryloxy, silyloxy, heterocyclic oxy, acyloxy, carbamoyloxy, alkoxycarbonyloxy, aryloxycarbonyloxy, amino, which may be anilino, acylamino, aminocarbonylamino, alkoxycarbonylamino, aryloxycarbonylamino, sulfamoylamino, alkyl or arylsulfonylamino, mercapto, alkylthio, arylthio, heterocyclic thio, sulfamoyl, sulfo, alkyl or arylsufinyl, alkyl or arylsulfonyl, acyl, aryloxycarbonyl, alkoxycarbonyl, carbamoyl, aryl or heterocyclic azo, imide, phosphino, phosphinyl, phosphinyloxy, phosphinylamino or silyl.

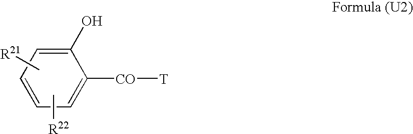

In the formula, R²¹, and R²² each independently represents a hydrogen or halogen atom, or the following group: alkyl, which may be cycloalkyl or bicycloalkyl, alkenyl, which may be cycloalkenyl or bicycloalkenyl, alkynyl, aryl, heterocyclic, cyano, hydroxyl, nitro, carboxyl, alkoxy, aryloxy, silyloxy, heterocyclic oxy, acyloxy, carbamoyloxy, alkoxycarbonyloxy, aryloxycarbonyloxy, amino, which may be anilino, acylamino, aminocarbonylamino, alkoxycarbonylamino, aryloxycarbonylamino, sulfamoylamino, alkyl or arylsulfonylamino, mercapto, alkylthio, arylthio, heterocyclic thio, sulfamoyl, sulfo, alkyl or arylsufinyl, alkyl or arylsulfonyl, acyl, aryloxycarbonyl, alkoxycarbonyl, carbamoyl, aryl or heterocyclic azo, imide, phosphino, phosphinyl, phosphinyloxy, phosphinylamino or silyl. T represents an aryl, heterocyclic or aryloxy group. T is preferably an aryl group.

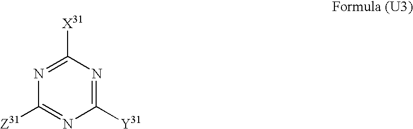

In the formula, X³¹, Y³¹ and Z³¹ each independently represents a substituted or unsubstituted alkyl, aryl, alkoxy, aryloxy, alkylthio, arylthio, or heterocyclic group provided that at least one of X³¹, Y³¹ and Z³¹ represents a group represented by the following formula (a).

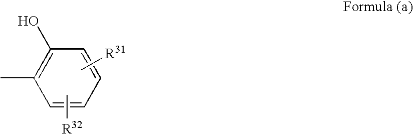

In the formula, R³¹ and R³² each independently represents a hydrogen or halogen atom, or the following group: alkyl, which may be cycloalkyl or bicycloalkyl, alkenyl, which may be cycloalkenyl or bicycloalkenyl, alkynyl, aryl, heterocyclic, cyano, hydroxyl, nitro, carboxyl, alkoxy, aryloxy, silyloxy, heterocyclic oxy, acyloxy, carbamoyloxy, alkoxycarbonyloxy, aryloxycarbonyloxy, amino, which may be anilino, acylamino, aminocarbonylamino, alkoxycarbonylamino, aryloxycarbonylamino, sulfamoylamino, alkyl or arylsulfonylamino, mercapto, alkylthio, arylthio, heterocyclic thio, sulfamoyl, sulfo, alkyl or arylsufinyl, alkyl or arylsulfonyl, acyl, aryloxycarbonyl, alkoxycarbonyl, carbamoyl, aryl or heterocyclic azo, imide, phosphino, phosphinyl, phosphinyloxy, phosphinylamino or silyl. When R³¹ and R³² are adjacent, R³¹ and R³² may be linked with each other to form a ring.

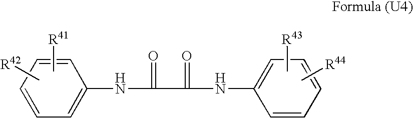

In the formula, R⁴¹ to R⁴⁴ each independently represents a hydrogen or halogen atom, or the following group: alkyl, which may be cycloalkyl or bicycloalkyl, alkenyl, which may be cycloalkenyl or bicycloalkenyl, alkynyl, aryl, heterocyclic, cyano, hydroxyl, nitro, carboxyl, alkoxy, aryloxy, silyloxy, heterocyclic oxy, acyloxy, carbamoyloxy, alkoxycarbonyloxy, aryloxycarbonyloxy, amino, which may be anilino, acylamino, aminocarbonylamino, alkoxycarbonylamino, aryloxycarbonylamino, sulfamoylamino, alkyl or arylsulfonylamino, mercapto, alkylthio, arylthio, heterocyclic thio, sulfamoyl, sulfo, alkyl or arylsufinyl, alkyl or arylsulfonyl, acyl, aryloxycarbonyl, alkoxycarbonyl, carbamoyl, aryl or heterocyclic azo, imide, phosphino, phosphinyl, phosphinyloxy, phosphinylamino or silyl.

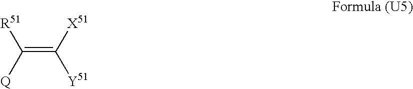

In the formula, Q represents an aryl group, or a 5- or 6-membered heterocyclic group, R51 represents a hydrogen atom or an alkyl group, and X⁵¹ and Y⁵¹ each independently represents a cyano group, —COOR⁵², —CONR⁵²R⁵³, —COR⁵², —SO₂OR⁵², or —SO₂NR⁵²R⁵³ wherein R⁵² and R⁵³ each independently represents a hydrogen atom, or an alkyl or aryl group. Either R⁵² or R⁵³ is preferably a hydrogen atom. X⁵¹ and Y⁵¹ may be linked with each other to form a 5- or 6-membered ring. When X⁵¹ and Y⁵¹ are each a carboxyl group, the group may be in the form of a salt.

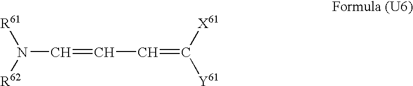

In the formula, R⁶¹ and R⁶² each independently may be the same or different, and represent a hydrogen atom, or an alkyl or aryl group, or R61 and R62 may be bonded to each other to form a 5- or 6-membered ring composed of the N atom and nonmetallic atoms. Alternatively, any one of R⁶¹ and R⁶² may be bonded to the methine group adjacent to the nitrogen atom to form a 5- or 6-membered ring. X⁶¹ and Y⁶¹ may be the same or different, and have the same meanings as X⁵¹ and Y⁵¹ in the formula (U5), respectively.

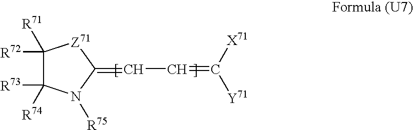

In the formula, R⁷¹ to R⁷⁴ each independently represents a hydrogen atom, an alkyl or aryl group, and R⁷¹ and R⁷⁴ may be combined with each other to form a double bond. When R⁷¹ and R⁷⁴ are combined with each other to form a double bond, R⁷² and R⁷³ may be linked with each other to form a benzene ring or naphthalene ring. R⁷⁵ represents an alkyl or aryl group, and Z⁷¹ represents an oxygen or sulfur atom, or a methylene, ethylene group, >N—R⁷⁶ wherein R⁷⁶ represents an alkyl or aryl group, or >C(R⁷⁷)(R⁷⁸) wherein R⁷⁷ and R⁷⁸ may be the same or different, and each represent a hydrogen atom or an alkyl group. X⁷¹ and Y⁷¹ may be the same or different, and have the same meanings as X⁵¹ and Y⁵¹ in the formula (U5), respectively. n represents 0 or 1.

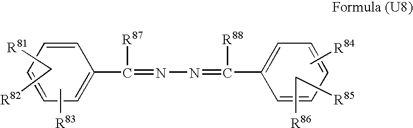

In the formula, R⁸¹ and R⁸⁶ each independently represents a hydrogen or halogen atom, or the following group: alkyl, which may be cycloalkyl or bicycloalkyl, alkenyl, which may be cycloalkenyl or bicycloalkenyl, alkynyl, aryl, heterocyclic, cyano, hydroxyl, nitro, carboxyl, alkoxy, aryloxy, silyloxy, heterocyclic oxy, acyloxy, carbamoyloxy, alkoxycarbonyloxy, aryloxycarbonyloxy, amino, which may be anilino, acylamino, aminocarbonylamino, alkoxycarbonylamino, aryloxycarbonylamino, sulfamoylamino, alkyl or arylsulfonylamino, mercapto, alkylthio, arylthio, heterocyclic thio, sulfamoyl, sulfo, alkyl or arylsufinyl, alkyl or arylsulfonyl, acyl, aryloxycarbonyl, alkoxycarbonyl, carbamoyl, aryl or heterocyclic azo, imide, phosphino, phosphinyl, phosphinyloxy, phosphinylamino or silyl. R⁸⁷ and R⁸⁸ may be the same or different, and each represent a hydrogen atom, or an alkyl or aryl group. R⁸⁷ and R⁸⁸ may be linked with each other to form a 5- or 6-membered ring.

In the formulae (U1) to (U8) and the formula (a), each of the substituents (for example, the group having an alkyl moiety, aryl moiety or heterocyclic moiety) may be substituted with one or more substituents examples of which will be described below. The description of each of the substituents in the formulae (U1) to (U8) and the formula (a), and specific examples thereof are identical to the description and specific examples of the corresponding group out of descriptions and specific examples described below.

Such groups are described and illustrated bellow.

Examples of substituent groups include halogen atoms (for example, a chlorine atom, bromine atom, and iodine atom), alkyl groups [straight-chain, branched, or cyclic substituted or unsubstituted alkyl group; specific examples thereof include alkyl groups (preferably alkyl groups having 1 to 30 carbon atoms, such as methyl, ethyl, n-propyl, isopropyl, t-butyl, n-octyl, eicosyl, 2-chloroethyl, 2-cyanoethyl, and 2-ethylhexyl), cycloalkyl groups (preferably, substituted or unsubstituted cycloalkyl groups having 3 to 30 carbon atoms, such as cyclohexyl, cyclopentyl, and 4-n-dodecylcyclohexyl), bicycloalkyl groups (preferably, substituted or unsubstituted bicycloalkyl groups having 5 to 30 carbon atoms, that is, monovalent groups of bicycloalkane having 5 to 30 carbon atoms from which one hydrogen atom was removed, such as bicyclo[1,2,2]heptan-2-yl and bicyclo[2,2,2]octan-3-yl), tricycle structures containing more cyclic structures, and the like; and an alkyl group in a substituent group described below (for example, an alkyl group in an alkylthio group) is also the alkyl group in the same meaning], alkenyl groups [straight-chain, branched or cyclic substituted or unsubstituted alkenyl groups; alkenyl groups (including preferably, substituted or unsubstituted alkenyl groups having 2 to 30 carbon atoms, such as vinyl, allyl, prenyl, geranyl, and oleyl), including cycloalkenyl groups (preferably, substituted or unsubstituted cycloalkenyl groups having 3 to 30 carbon atoms, that is, monovalent groups of cycloalkene having 3 to 30 carbon atoms, from which one hydrogen atom was removed, such as 2-cyclopenten-1-yl and 2-cyclohexen-1-yl), and bicycloalkenyl groups (substituted or unsubstituted bicycloalkenyl groups, preferably substituted or unsubstituted bicycloalkenyl groups having 5 to 30 carbon atoms, that is, monovalent groups of bicycloalkene having one double bond from which one hydrogen atom was removed,

for example, bicyclo[2,2,1]hept-2-en-1-yl and bicyclo[2,2,2]oct-2-en-4-yl)], alkynyl groups (preferably, substituted or unsubstituted alkynyl groups having 2 to 30 carbon atoms, such as ethynyl, propargyl, and trimethylsilylethynyl), aryl groups (preferably, substituted or unsubstituted aryl groups having 6 to 30 carbon atoms, such as phenyl, p-tolyl, naphthyl, m-chlorophenyl, and o-hexadecanoylaminophenyl), heterocyclic groups (monovalent groups, preferably five- or six-membered substituted or unsubstituted, aromatic or non-aromatic heterocyclic compounds from which one hydrogen atom was removed, more preferably, five- or six-membered heteroaromatic ring groups having 3 to 30 carbon atoms, such as 2-furyl, 2-thienyl, 2-pyrimidinyl, and 2-benzothiazolyl),

a cyano group, a hydroxyl group, a nitro group, a carboxyl group, alkoxy groups (preferably, substituted or unsubstituted alkoxy groups having 1 to 30 carbon atoms, such as methoxy, ethoxy, isopropoxy, t-butoxy, n-octyloxy, and 2-methoxyethoxy), aryloxy groups (preferably, substituted or unsubstituted aryloxy groups having 6 to 30 carbon atoms, such as phenoxy, 2-methylphenoxy, 4-t-butylphenoxy, 3-nitrophenoxy, and 2-tetradecanoylaminophenoxy), silyloxy groups (preferably silyloxy groups having 3 to 20 carbon atoms, such as trimethylsilyloxy and t-butyldimethylsilyloxy),

heterocyclic oxy groups (preferably, substituted or unsubstituted heterocyclic oxy groups having 2 to 30 carbon atoms, such as 1-phenyltetrazol-5-oxy and 2-tetrahydropyranyloxy), acyloxy groups (preferably, a formyloxy group, substituted or unsubstituted alkylcarbonyloxy groups having 2 to 30 carbon atoms, and substituted or unsubstituted arylcarbonyloxy groups having 6 to 30 carbon atoms, such as formyloxy, acetyloxy, pivaloyloxy, stearoyloxy, benzoyloxy, and p-methoxyphenylcarbonyloxy), carbamoyloxy groups (preferably, substituted or unsubstituted carbamoyloxy group having 1 to 30 carbon atoms, such as N,N-dimethylcarbamoyloxy, N,N-diethylcarbamoyloxy, morpholinocarbonyloxy, N,N-di-n-octylaminocarbonyloxyl, and N-n-octylcarbamoyloxy), alkoxycarbonyloxy groups (preferably, substituted or unsubstituted alkoxycarbonyloxy groups having 2 to 30 carbon atoms, such as methoxycarbonyloxy, ethoxycarbonyloxy, t-butoxycarbonyloxy, and n-octylcarbonyloxy),

aryloxycarbonyloxy groups (preferably, substituted or unsubstituted aryloxycarbonyloxy groups having 7 to 30 carbon atoms, such as phenoxycarbonyloxy, p-methoxyphenoxycarbonyloxy, and p-n-hexadecyloxyphenoxycarbonyloxy), amino groups (preferably, an amino group, substituted or unsubstituted alkylamino groups having 1 to 30 carbon atoms, and substituted or unsubstituted anilino groups having 6 to 30 carbon atoms, such as amino, methylamino, dimethylamine, anilino, N-methyl-anilino, and diphenylamino), acylamino groups (preferably, a formylamino group, substituted or unsubstituted alkylcarbonylamino groups having 1 to 30 carbon atoms, and substituted or unsubstituted arylcarbonylamino groups having 6 to 30 carbon atoms, such as formylamino, acetylamino, pivaloylamino, lauroylamino, benzoylamino, and 3,4,5-tri-n-octyloxyphenylcarbonylamino), aminocarbonylamino groups (preferably, substituted or unsubstituted aminocarbonylamino groups having 1 to 30 carbon atoms, such as carbamoylamino, N,N-dimethylaminocarbonylamino, N,N-diethylaminocarbonylamino, and morpholinocarbonylamino), alkoxycarbonylamino groups (preferably, substituted or unsubstituted alkoxycarbonylamino groups having 2 to 30 carbon atoms, such as methoxycarbonylamino, ethoxycarbonylamino, t-butoxycarbonylamino, n-octadecyloxycarbonylamino, and N-methyl-methoxycarbonylamino), aryloxycarbonylamino groups (preferably, substituted or unsubstituted aryloxycarbonylamino groups having 7 to 30 carbon atoms, such as phenoxycarbonylamino, p-chlorophenoxycarbonylamino, and m-n-octyloxyphenoxycarbonylamino), sulfamoylamino groups (preferably, substituted or unsubstituted sulfamoylamino groups having 0 to 30 carbon atoms, such as sulfamoylamino, N,N-dimethylaminosulfonylamino, and N-n-octylaminosulfonylamino), alkyl and arylsulfonylamino groups (preferably, substituted or unsubstituted alkylsulfonylamino groups having 1 to 30 carbon atoms, and substituted or unsubstituted arylsulfonylamino groups having 6 to 30 carbon atoms, such as methylsulfonylamino, butylsulfonylamino, phenylsulfonylamino, 2,3,5-trichlorophenylsulfonylamino, and p-methylphenylsulfonylamino),

a mercapto group, alkylthio groups (preferably, substituted or unsubstituted alkylthio groups having 1 to 30 carbon atoms, such as methylthio, ethylthio, and n-hexadecylthio), arylthio groups (preferably, substituted or unsubstituted arylthio groups having 6 to 30 carbon atoms, such as phenylthio, p-chlorophenylthio, and m-methoxyphenylthio), heterocyclic thio groups (preferably, substituted or unsubstituted heterocyclic thio groups having 2 to 30 carbon atoms, such as 2-benzothiazolylthio and 1-phenyltetrazol-5-yl-thio), sulfamoyl groups (preferably, substituted or unsubstituted sulfamoyl groups having 0 to 30 carbon atoms, such as N-ethylsulfamoyl, N-(3-dodecyloxypropyl)sulfamoyl, N,N-dimethylsulfamoyl, N-acetylsulfamoyl, N-benzoylsulfamoyl, and N—(N′)-phenylcarbamoyl)sulfamoyl), a sulfo group, alkyl or arylsulfinyl groups (preferably, substituted or unsubstituted alkylsulfinyl groups having 1 to 30 carbon atoms and substituted or unsubstituted arylsulfinyl groups having 6 to 30 carbon atoms, such as methylsulfinyl, ethylsulfinyl, phenylsulfinyl, and p-methylphenylsulfinyl), alkyl or arylsulfonyl groups (preferably, substituted or unsubstituted alkylsulfonyl groups having 1 to 30 carbon atoms and substituted or unsubstituted arylsulfonyl groups having 6 to 30 carbon atoms, such as methylsulfonyl, ethylsulfonyl, phenylsulfonyl, and p-methylphenylsulfonyl), acyl groups (preferably a formyl group, substituted or unsubstituted alkylcarbonyl groups having 2 to 30 carbon atoms, substituted or unsubstituted arylcarbonyl groups having 7 to 30 carbon atoms, and substituted or unsubstituted heterocyclic carbonyl groups having 4 to 30 carbon atoms in which a carbonyl group is bonded to a carbon atom, such as acetyl, pivaloyl, 2-chloroacetyl, stearoyl, benzoyl, p-n-octyloxyphenylcarbonyl, 2-pyridylcarbonyl, and 2-furylcarbonyl), aryloxycarbonyl groups (preferably, substituted or unsubstituted aryloxycarbonyl groups having 7 to 30 carbon atoms, such as phenoxycarbonyl, o-chlorophenoxycarbonyl, m-nitrophenoxycarbonyl, and p-t-butylphenoxycarbonyl), alkoxycarbonyl groups (preferably, substituted or unsubstituted alkoxycarbonyl groups having 2 to 30 carbon atoms, such as methoxycarbonyl, ethoxycarbonyl, t-butoxycarbonyl, and n-octadecyloxycarbonyl), carbamoyl groups (preferably, substituted or unsubstituted carbamoyl groups having 1 to 30 carbon atoms, such as carbamoyl, N-methylcarbamoyl, N,N-dimethylcarbamoyl, N,N-di-n-octylcarbamoyl, and N-(methylsulfonyl)carbamoyl), aryl or heterocyclic azo groups (preferably, substituted or unsubstituted arylazo groups having 6 to 30 carbon atoms and substituted or unsubstituted heterocyclic azo groups having 3 to 30 carbon atoms, such as phenylazo, p-chlorophenylazo, and 5-ethylthio-1,3,4-thiadiazol-2-ylazo),

imido groups (preferably, N-succinimido and N-phthalimido), phosphino groups (preferably, substituted or unsubstituted phosphino groups having 2 to 30 carbon atoms, such as dimethylphosphino, diphenylphosphino, and methylphenoxyphosphino),

phosphinyl groups (preferably, substituted or unsubstituted phosphinyl groups having 2 to 30 carbon atoms, such as phosphinyl, dioctyloxyphosphinyl, and diethoxyphosphinyl), phosphinyloxy groups (preferably, substituted or unsubstituted phosphinyloxy groups having 2 to 30 carbon atoms, such as diphenoxyphosphinyloxy and dioctyloxyphosphinyloxy), phosphinylamino groups (preferably, substituted or unsubstituted phosphinylamino groups having 2 to 30 carbon atoms, such as dimethoxyphosphinylamino and dimethylaminophosphinylamino), silyl groups (preferably, substituted or unsubstituted silyl groups having 3 to 30 carbon atoms, such as trimethylsilyl, t-butyldimethylsilyl, and phenyldimethylsilyl), and the like.

Among the functional groups above, those containing a hydrogen atom may be deprived of their hydrogen atom and substituted by one of the above groups in place of the hydrogen atom. Examples of such functional groups include alkylcarbonylaminosulfonyl groups, arylcarbonylaminosulfonyl groups, alkylsulfonylaminocarbonyl groups, and arylsulfonylaminocarbonyl groups. Specific examples include a methylsulfonylaminocarbonyl group, a p-methylphenylsulfonylaminocarbonyl group, an acetylaminosulfonyl group, and a benzoylaminosulfonyl group.

When the ultraviolet absorbents represented by the formulae (U1) to (U8) are water-soluble, it is preferred that the absorbents have an ionic hydrophilic group. Examples of the ionic hydrophilic group include sulfo, carboxyl, phosphono, and tertiary ammonium groups. The ionic hydrophilic group is preferably a carboxyl, phosphono, or sulfo group, and is in particular preferably a carboxyl or sulfo group. The carboxyl, phosphono, and sulfo groups may each be in the form of a salt. Examples of the counter ion which constitutes the salt include an ammonium ion, alkali metal ions (for example, lithium, sodium, potassium ions), and organic cations (for example, tetramethylammonium, tetramethylguanidium, and tetramethylphosphonium ions).

Among the ultraviolet absorbents represented by the formulae (U1) to (U8), the absorbents represented by the formulae (U1) to (U4) are preferred since the absorbents themselves are high in fastness against light. From the viewpoint of absorption characteristics, absorbents represented by the formulae (U1) to (U3) are preferred, and those represented by the formulae (U1) and (U3) are particularly preferred. When the ultraviolet absorbents are used under a basic condition, the compounds represented by the formula (U4) to (U8) are preferred since the compounds are not colored by the dissociation thereof.

The compounds represented by the formulae (U1) to (U8) can be synthesized by methods described in JP-B Nos. 48-30492, 55-36984, 55-125875, 36-10466, and 48-5496, JP-A Nos. 46-3335, 58-214152, 58-221844, 47-10537, 59-19945, 63-53544, 51-56620, 53-128333, 58-181040, 06-211813, 07-258228, 08-239368, 08-53427, 10-115898, 10-147577, and 10-182621, Japanese Patent Application National Publication (Laid-Open) No. 08-501291, U.S. Pat. Nos. 3,754,919, 4,220,711, 2,719,086, 3,698,707, 3,707,375, 5,298,380, 5,500,332, 5,585,228, and 5,814,438, GB Patent No. 1,198,337, EP Nos. 323408A, 520938A, 521823A, 531258A, 530135A and 520938A, and other documents, or methods similar to these methods.

Structures of typical ultraviolet absorbents, and physical properties and effect mechanism thereof are described in Andreas Valet, “Light Stabilizers for Paint”, published by Vincentz.

(Heat-Resistant Lubricant Layer)

The thermal transfer sheet is traveled while the rear face thereof directly contacts a heating device, such as a thermal head, so as to be heated therewith. Therefore a heat-resistant lubricant layer is formed thereon in the exemplary embodiment of the invention in order to prevent thermal melt-bonding between this rear face and the heating device so as to make the traveling smooth.

The heat-resistant lubricant layer may be made of one selected from or a mixture of two or more selected from natural and synthetic resins, for example, cellulose resins such as ethylcellulose, hydroxycellulose, hydroxypropylcellulose, methylcellulose, cellulose acetate, cellulose acetate butyrate and nitro cellulose, vinyl resins such as polyvinyl alcohol, polyvinyl acetate, polyvinyl butyral, polyvinyl acetal and polyvinyl pyrrolidone, acrylic resins such as methyl polymethacrylate, polyethyl acrylate, polyacrylamide and acrylonitrile/styrene copolymer, polyamide resin, polyvinyl toluene resin, coumarone indene resin, polyester resins, polyurethane resin, and silicon- or fluorine-modified resin, and silicone resin.

In order to improve the heat resistance of the heat-resistant lubricant layer, it is also preferred to use a crosslinking agent to render the layer a crosslinked resin layer.

In order to improve the traveling performance, it is preferred to incorporate a releasing agent or lubricant in a solid or liquid form into the heat-resistant lubricant layer. The chemical agent may be a known agent, and examples thereof include various waxes such as zinc stearate, stearic amide, carnauba wax, montan wax, polyethylene wax and paraffin wax, higher aliphatic acid esters, higher aliphatic alcohols, organopolysiloxane, anionic surfactants, cationic surfactants, amphoteric surfactants, nonionic surfactants, fluorine-contained surfactants, organic carboxylic acids and derivatives thereof, fluorine-contained resins, silicone resins, phosphate compounds, and organic or inorganic fine particles.

This heat-resistant lubricant layer may be formed by a known coating method. The thickness thereof is preferably from 0.1 to 10 μm, more preferably from 0.3 to 5 μm, even more preferably from 0.5 to 3 μm.

2) Thermosensitive Transfer Image-Receiving Sheet

Next, the thermosensitive transfer image-receiving sheet (image-receiving sheet) used in the invention will be described hereinafter.

The thermosensitive transfer image-receiving sheet has a support, at least one dye-receiving layer (receiving layer) over the support, and at least heat insulating layer (porous layer) between the support and the receiving layer. Between the receiving layer and the heat insulating layer may be formed an underlying layer such as a white background adjusting layer, an electrostatic charge controlling layer, an adhesive layer, or a primer layer.

The receiving layer and the heat insulating layer are preferably formed by simultaneous multilayer painting. In the case that the image-receiving sheet contains the underlying layer, the receiving layer, the underlying layer and the heat insulating layer may be formed by simultaneous multilayer painting (i.e., multi-painting or multi-coating).

It is preferred that a curl adjusting layer, a writing layer, and an electrostatic charge controlling layer are formed on the rear face side of the support. The painting of each of the layers on the rear face side of the support may be attained by an ordinary method such as roll coating, bar coating, gravure coating, or gravure reverse coating.

<Receiving Layer>

[Thermoplastic Resin]

In the invention, it is preferred that a thermoplastic resin is used in the receiving layer. Preferred examples of the thermoplastic resin include halogenated polymers such as polyvinyl chloride and polyvinylidene chloride, vinyl resins such as polyvinyl acetate, ethylene/vinyl acetate copolymer, vinyl chloride/vinyl acetate copolymer, polyacrylester, polystyrene and acrylic polystyrene, acetal resins such as polyvinyl formal, polyvinyl butyral and polyvinyl acetal, polyester resins such as polyethylene terephthalate, polybutylene terephthalate and polycaprolactone (trade name: PRACSEL (transliteration) H-5, manufactured by Daicel Chemical Industries, Ltd.), polycarbonate resins, cellulose resins described in JP-A Nos. 04-296595 and 2002-264543, cellulose acetate butyrates manufactured by Eastman Chemical Co. (trade names: CAB 551-0.2 and CAB 321-0.1), polyolefin resins such as polypropylene, and polyamide resins such as urea resin, melamine resin and benzoguanamine resin. Two or more of these resins may be blend at will for use as long as the blended resins are compatible with each other. Resins which may constitute the receiving layer are disclosed in JP-A Nos. 57-169370, 57-207250 and 60-25793, and others.

Of the above-mentioned polymers, polycarbonates, polyesters, polyurethane, polyvinyl chloride and copolymers thereof, styrene/acrylonitrile copolymer, polycaprolactone, or mixtures thereof are more preferred. Polycarbonates, polyesters, polyvinyl chloride and copolymers thereof, or mixtures thereof are even more preferred. The above-mentioned polymers may be used alone or in the form of a mixture thereof. Polycarbonates, polyesters, and polyvinyl chloride will be described in more detail hereinafter.

[Polyester Polymers]

The polyester polymers each used in the receiving layer are described in more detail herein. The polyesters are each obtained by polycondensing a dicarboxylic acid component, which may be a derivative thereof, and a diol component, which may be a derivative thereof. The polyester polymers each contain an aromatic ring and/or an alicyclic ring. About techniques about the alicyclic polyester, a technique described in JP-A No. 05-238167 is effective from the viewpoint of dye-taking-in performance and the stability of an image.

The dicarboxylic acid component may be selected from adipic acid, azelaic acid, isophthalic acid, trimellitic acid, terephthalic acid, 1,4-cyclohexanedicarboxylic acid, and mixtures of two or more thereof, and is preferably selected from isophthalic acid, trimellitic acid, terephthalic acid, and mixtures of two or more thereof. The polyester polymer desirably contains, as the dicarboxylic acid component, an alicyclic component in order to improve the light resistance. More preferably, 1,4-cyclohexanedicarboxylic acid and isophthalic acid are used. The above-mentioned dicarboxylic acids may be used at the following percentages: 50 to 100% by mole of isophthalic acid, 0 to 1% by mole of trimellitic acid, 0 to 50% by mole of terephthalic acid, and 0 to 15% by mole of 1,4-cyclohexanedicarboxylic acid, the percentage of the total thereof being 100% by mole.

The diol component may be selected from ethylene glycol, polyethylene glycol, tricyclodecanedimethanol, 1,4-butanediol, bisphenol, and mixtures of two or more thereof, preferably from ethylene glycol, polyethylene glycol, and tricyclodecanedimethanol. The polyester resin desirably contains, as the diol component, an alicyclic component to improve the light resistance. Cyclohexanediol, cyclohexanedimethanol, cyclohexanediethanol, or some other alicyclic diol component may be used besides tricyclodecanedimethanol. The alicyclic diol component is preferably tricyclodecanedimethanol. Such diol components may be used at the following percentages: 0 to 50% by mole of ethylene glycol, 0 to 10% by mole of polyethylene glycol, 0 to 90% by mole of tricyclodecanedimethanol, preferably 30 to 90% by mole thereof, more preferably 40 to 90% by mole thereof, 0 to 50% by mole of 1,4-butanediol, and 0 to 50% by mole of bisphenol A, the percentage of the total thereof being 100% by mole.

In the invention, there is used a polyester polymer obtained by polycondensing at least the above-mentioned dicarboxylic acid component and diol component so as to give a molecular weight (weight-average molecular weight (Mw) usually of about 11000 or more, preferably of about 15000 or more, more preferably of about 17000 or more. If a polyester polymer the molecular weight of which is too low is used, the elasticity of the formed receiving layer becomes low and the heat resistance also becomes insufficient. Thus, it may be difficult to keep the releasability between the thermosensitive transfer sheet and the image-receiving sheet certainly. As the molecular weight is larger, a more desirable result is obtained in order to raise the elasticity. The molecular weight is not particularly limited as long as the following is not caused: when the receiving layer is formed, the polymer cannot be dissolved in the solvent in the coating-solution; after the receiving layer is applied and dried, a bad effect is produced on the adhesiveness thereof onto the support; or any other different bad result is caused. The molecular weight is preferably about 25000 or lower, and is at highest about 30000. The polyester polymer may be synthesized by a method known in the prior art.

A saturated polyester that may be used is, for example, a polyester manufactured by Toyobo Co., Ltd. (trade name: BYRON [transliteration] 200, 290 or 600), a polyester manufactured by Arakawa Chemical Industries, Ltd. (trade name: KA-1038C), or a polyester manufactured by the Nippon Synthetic Chemical Industry Co., Ltd. (trade name: TP220 or TP235).

[Polycarbonate Polymers]

The polycarbonate polymers each used in the receiving layer are described in more detail herein. Polycarbonate means a polyester having carbon dioxide and a diol as units. The polycarbonate polymers may each be synthesized by a process of causing a diol to react with phosgene, or a process of causing a diol to react with a carbonate ester.

Preferred examples of the diol component include bisphenol A, ethylene glycol, propylene glycol, diethylene glycol, butanediol, pentanediol, hexanediol, 1,4-cyclohexanedimethanol, nonanediol, 4,4′-bicyclo(2,2,2)hept-2-ylidenebisphenol, 4,4′-(octahydro-4,7-methano-5H-indene-5-ylidene)bisphenol, and 2,2′,6,6′-tetrachlorobisphenol A. Preferred are bisphenol A, ethylene glycol, diethylene glycol, butanediol and pentanediol. More preferred are bisphenol A, ethylene glycol and butanediol, and even more preferred are bisphenol A and ethylene glycol. In the invention, at least one out of diol components as described above is used, and two or more thereof may be used in a mixture form.

Bisphenol A polycarbonate, which is a particularly preferred example of the polycarbonates that may be used in the invention, is described in detail. Technique of modified polycarbonates, a main example of which is bisphenol A polycarbonate, is described in U.S. Pat. No. 4,695,286. The polycarbonates each used in the invention are polycarbonates obtained by polycondensation and having a molecular weight usually of about 1000 or more, preferably of about 3000 or more, more preferably of about 5000 or more, even more preferably of about 10000 or more. Examples thereof include a polycarbonate manufactured by Bayer AG (trade name: MAKROLON-5700), and a polycarbonate manufactured by General Electric Co. (trade name: LEXAN-141).

A technique of mixing bisphenol A and a diol, such as ethylene glycol, to produce a modified polycarbonate is described in U.S. Pat. No. 4,927,803. The polyether block unit therein may be made from a linear aliphatic diol having 2 to about 10 carbon atoms, and is preferably made from ethylene glycol. In a preferred exemplary embodiment of the invention, the polyether block unit has a number-average molecular weight of about 4,000 to about 50,000, and the bisphenol A polycarbonate block unit has a number-average molecular weight of about 15,000 to about 250,000. The whole of this block copolymer has a molecular weight of about 30,000 to about 300,000. Specific examples of such a modified polycarbonate include a modified polycarbonate manufactured by Bayer AG (trade name: MAKROLON KL3-1013).

It is also preferred to mix an unmodified bisphenol polycarbonate and a modified bisphenol polycarbonate as described above, and it is preferred to mix an unmodified bisphenol A polycarbonate and a polyether modified polycarbonate at a ratio by mass of 80/20 to 10/90. The ratio by mass is more preferably from 50/50 to 40/60 in order to improve the fingerprint resistance. A technique of blending unmodified and modified bisphenol A polycarbonates is described in JP-A No. 06-227160 also.

A preferred example of the thermoplastic resin used in the receiving layer is a blend system of a polycarbonate and a polyester as described above. In this blend system, it is preferred to keep the compatibility between the polycarbonate and the polyester certainly. The polyester preferably exhibits a glass transition temperature (Tg) of about 40 to about 100° C. The polycarbonate preferably exhibits a Tg of about 100 to about 200° C. The polyester exhibits a lower Tg than the polycarbonate, and acts as a polymer plasticizer onto the polycarbonate. The Tg of the final blend of the polyester and polycarbonate is preferably from 40 to 100° C. A polymer made of a polyester and a polycarbonate and having a higher Tg may also become useful by adding a plasticizer to the polymer.

In a more preferred exemplary embodiment, an unmodified bisphenol A polycarbonate and a polyester polymer are blended at a ratio by mass at which the Tg of the final blend is made into a desired value and further costs are controlled into the lowest value. The polycarbonate and the polyester polymer can be conveniently blended at a ratio by mass of about 75/25 to 25/75, preferably about 60/40 to about 40/60. A technique of a blend system made of a polycarbonate and a polyester is disclosed in JP-A No. 06-227161.

About the polycarbonates that may be used in the receiving layer, a polycarbonate having, at its polymer terminals, at least two hydroxyl groups and having an average molecular weight of about 1000 to about 10,000 and a crosslinking agent reactive with hydroxyl groups may be caused to react with each other to form a crosslinked polymer network structure in the receiving layer. As described in JP-A No. 06-155933, a technique about a crosslinking agent such as a polyfunctional isocyanate is also known, and the technique makes it possible to improve the adhesiveness of the layer onto the dye donor after the dye is transferred. Furthermore, as disclosed in JP-A No. 08-39942, known is a technique of constructing an image-receiving sheet for thermosensitive transfer, using dibutyltin diacetate at the time of crosslinking reaction between a polycarbonate and an isocyanate. The technique makes it possible to not only promote the crosslinking reaction but also improve the image stability and the fingerprint resistance.

[Vinyl Chloride Polymer]

The vinyl chloride polymer used in the receiving layer, in particular, a copolymer wherein vinyl chloride is used is described in more detail herein.

The vinyl chloride copolymer is preferably a copolymer having a vinyl chloride content by percentage of 85 to 97% by mass and a polymerization degree of 200 to 800. The monomer copolymerized with vinyl chloride is not particularly limited as long as the monomer is copolymerizable with vinyl chloride. The monomer is preferably vinyl acetate. Accordingly, the vinyl chloride polymer used in the image-receiving sheet is very satisfactorily a vinyl chloride/vinyl acetate copolymer. The vinyl chloride/vinyl acetate copolymer is not necessarily a copolymer made only of a vinyl chloride component and a vinyl acetate component; thus, the copolymer may contain a vinyl alcohol component, a maleic acid component, or the like as long as the attainment of the objects of the invention is not hindered. Examples of such a different monomer component, which partially constitutes the copolymer made mainly of vinyl chloride and vinyl acetate, include vinyl alcohol derivatives such as vinyl alcohol and vinyl propionate; acrylic acid and methacrylic acid derivatives such as acrylic acid and methacrylic acid, and methyl, ethyl, propyl, butyl and 2-ethylhexyl esters thereof; maleic acid derivatives such as maleic acid, diethyl maleate, dibutyl maleate and dioctyl maleate; vinyl ether derivatives such as methyl vinyl ether, butyl vinyl ether and 2-ethylhexyl vinyl ether; and other compounds such as acrylonitrile, methacrylonitrile and styrene. The component ratio between vinyl chloride and vinyl acetate in the copolymer may be an arbitrary ratio. Preferably, the ratio of the vinyl chloride component is 50% or more by mass in the copolymer. The above-mentioned component other than vinyl chloride and vinyl acetate is preferably 10% or less by mass.

Examples of such a vinyl chloride/vinyl acetate copolymer include copolymers manufactured by Nissin Chemical Industry Co., Ltd. (trade names: SOLBIN C, SOLBIN CL, SOLBIN CH, SOLBIN CN, SOLBIN C5, SOLBIN M, SOLBIN MF, SOLBIN A, SOLBIN AL, SOLBIN TA5R, SOLBIN TAO, SOLBIN MK6, and SOLBIN TA2), copolymers manufactured by Sekisui Chemical Co., Ltd. (trade names: ESLECK [transliteration] A, ESLECK C, and ESLECK M), copolymers manufactured by Union Carbide Corp. (trade names: VYNILIGHT [transliteration] VAGH, VYNILIGHT VYHH, VYNILIGHT VMCH, VYNILIGHT VYHD, VYNILIGHT VYLF, VYNILIGHT VYNS, VYNILIGHT VMCC, VYNILIGHT VMCA, VYNILIGHT VAGD, VYNILIGHT VERR, VYNILIGHT VROH), and copolymers manufactured by Denki Kagaku Kogyo Kabushiki Kaisha (trade names: DENKA VINYL 1000GKT, DENKA VINYL 1000L, DENKA VINYL 1000CK, DENKA VINYL 1000A, DENKA VINYL 1000LK2, DENKA VINYL 1000AS, DENKA VINYL 1000MT2, DENKA VINYL 1000CSK, DENKA VINYL 1000CS, DENKA VINYL 1000GK, DENKA VINYL 1000GSK, DENKA VINYL 1000GS, DENKA VINYL 1000LT3, DENKA VINYL 1000D, and DENKA VINYL 1000W).

[Polymer Latex]

In the invention, a polymer latex can be preferably used besides the above-mentioned components. The polymer latex will be described hereinafter.

In the thermosensitive transfer image-receiving sheet used in the invention, the polymer latex, which may be used in its receiving layer, is preferably a latex wherein a hydrophobic polymer containing water-insoluble vinyl chloride as its monomer unit is dispersed, in the form of fine particles, in a water-soluble dispersing medium. About the dispersion state thereof, the polymer may be a polymer emulsified in the dispersing medium, a polymer obtained by emulsion polymerization, or a micelle-dispersed polymer. Alternatively, the polymer may be a polymer partially having, in the molecule thereof, a hydrophilic structure, its molecular chain itself being molecularly dispersed. Polymer latex is described in “Synthetic Resin Emulsion” edited by Taira Okuda and Hiroshi Inagaki and published by Koubunsi Kankoukai (1978); “Application of Synthetic Resin Latex” edited by Takaaki Sugimura, Yasuo Kataoka, Sohichi Suzuki and Keiji Kasahara and published by Koubunsi Kankoukai (1993); Sohichi Muroi, “Chemistry of Synthetic Latex” published by Koubunsi Kankoukai (1970); “Development and Application of Water-Based Coating Material” supervised by Yoshiaki Mishirosawa and published by CMC Publishing Co., Ltd. (2004); JP-A No. 64-538; and others. The average particle size of the dispersed particles is preferably from about 1 to 50000 nm, more preferably from about 5 to 1000 nm.

The particle size distribution of the dispersed particles is not particularly limited, and may be a broad particle size distribution or a monodispersive particle size distribution.

The polymer latex may be a polymer latex having an ordinary uniform structure, or the so-called core-shell type latex. In the latter, it is preferred in some cases that the glass transition temperature of the core and that of the shell are made different from each other. The glass transition temperature of the polymer latex used in the invention is preferably from −30 to 100° C., more preferably from 0 to 80° C., even more preferably from 10 to 70° C., even more preferably from 15 to 60° C.

The polymer latex used in the receiving layer is preferably a polyvinyl chloride, a copolymer containing, as its monomer unit, vinyl chloride, for example, vinyl chloride/vinyl acetate copolymer or vinyl chloride/acrylic compound copolymer. In this case, the ratio of the vinyl chloride monomer is preferably from 50 to 95%. The polymer may be a linear polymer, a branched polymer, or a crosslinked polymer, and may be a homopolymer, which is obtained by polymerizing a single monomer, or a copolymer, which is obtained by polymerizing two or more monomers. In the case of the copolymer, the polymer is a random copolymer or a block copolymer. The number-average molecular weight of the polymer is usually from 5000 to 1000000, preferably from 10000 to 500000. If the molecular weight is too small, the dynamic strength of the layer containing the latex may be insufficient. If the molecular weight is too large, the film-formability may be poor. A crosslinking polymer latex is also preferably used.

The polymer latex that can be used in the invention is commercially available. The following polymer latexes may be used: for example, polymers manufactured by Nippon Zeon Co., Ltd. (trade names: G351 and G576), and polymers manufactured by Nissin Chemical Industry Co., Ltd. (trade names: VINYBRAN's [transliteration] 240, 270, 277, 375, 386, 609, 550, 601, 602, 630, 660, 671, 683, 680, 680S, 681N, 685R, 277, 380, 381, 410, 430, 432, 860, 863, 865, 867, 900, 900GT, 938, and 950).

These polymer latexes may be used alone or may be optionally used in the form of a blend of two or more thereof.

In the receiving layer, the ratio of the copolymer latex containing as its monomer unit vinyl chloride is preferably 50% or more of all solid components in the layer.

In the present invention, the receiving layer is preferably prepared by coating a water-based coating liquid followed by drying. The “water-based” referred to herein means that the solvent of the coating liquid (dispersion medium) contains water in an amount of 60% by mass or greater. Examples of the ingredient which may be used other than water in the coating liquid include water miscible organic solvents such as methyl alcohol, ethyl alcohol, isopropyl alcohol, methyl cellosolve, ethyl cellosolve, dimethylformamide, ethyl acetate, diacetone alcohol, furfuryl alcohol, benzyl alcohol, diethyleneglycol monoethyl ether and oxyethylphenyl ether.

The minimum film-formable temperature (MFT) of the polymer latex is usually from about −30 to 90° C., preferably from about 0 to 70° C. In order to control the minimum film-formable temperature, a film-forming aid may be added to the latex. The film-forming aid is an organic compound (usually, an organic solvent) which is also called a temporary plasticizer and makes the minimum film-formable temperature of the polymer latex low, and is described in, for example, Sohichi Muroi, “Chemistry of Synthetic Latex” published by Koubunsi Kankoukai (1970). Preferred examples of the film-formability aid are listed up below. However, the film-forming aid that can be used in the invention is not limited to the listed-up examples.

Z-1: benzyl alcohol

Z-2: 2,2,4-trimethylpentanediol-1,3-monoisobutyrate

Z-3: 2-dimethylaminoethanol

Z-4: diethylene glycol

In the invention, the above-mentioned polymer latex may be used together with (i.e., be blended with) a different polymer latex. Preferred examples of the different polymer latex include polylactic acid ester latexes, polyurethane latexes, polycarbonate latexes, polyester latexes, polyacetal latexes, and SBR latexes. Of these examples, polyester and polycarbonate latexes are preferred.

Furthermore, the polymer latex that can be used in the invention may be used together with any polymer besides the different polymer latex. The polymer that may be used together is preferably transparent or semitransparent, and colorless. The polymer may be a natural resin, polymer or copolymer, a synthetic resin, polymer or copolymer, or a medium that can be formed into a film, and examples thereof include gelatins, polyvinyl alcohols, hydroxyethylcelluloses, cellulose acetates, cellulose acetate butyrates, polyvinyl pyrrolidones, casein, starches, polyacrylic acids, polymethyl methacrylates, polyvinyl chlorides, polymethacrylic acids, styrene/maleic anhydride copolymers, styrene/acrylonitrile copolymers, styrene/butadiene copolymers, polyvinyl acetals (such as polyvinyl formal and polyvinyl butyral), polyesters, polyurethanes, phenoxy resins, polyvinylidene chloride, polyepoxides, polycarbonates, polyvinyl acetates, polyolefins, and polyamides. The binder may be formed from water, an organic solvent or an emulsion into a film by covering.

The binder of the present invention preferably has a grass transition temperature (Tg) in a range of from −30° C. to 70° C., more preferably, in a range of from −10° C. to 50° C., and even more preferably in a range of from 0° C. to 40° C., considering manufacturing-related brittleness and image storability. Two or more polymers can be blended for the binder, and in this case, the blended polymer has a weighed averaged Tg which preferably falls within the range above, considering composition components. When the polymers exhibit phase separation or has a core-shell structure, a weighed averaged Tg preferably falls within the range above.

In the specification, Tg is calculated according to the following equation.

1/Tg=Σ(Xi/Tgi)

Where, the polymer is obtained by copolymerization of n monomer compounds (from i=1 to i=n); Xi represents the mass fraction of the ith monomer (ΣXi=1), and Tgi is the glass transition temperature (absolute temperature) of the homopolymer obtained with the ith monomer. The symbol Σ stands for the summation from i=1 to i=n. Values for the glass transition temperature (Tgi) of the homopolymers derived from each of the monomers are obtainable from J. Brandrup and E. H. Immergut, Polymer Handbook (3rd Edition) (Wiley-Interscience, 1989).

The polymer used for the binder of the invention can be readily obtained by a solution polymerizing method, a suspension polymerizing method, an emulsion polymerizing method, a dispersion polymerizing method, an anionic polymerizing method, a cationic polymerizing method, or the like, however most preferable is an emulsion polymerizing method by which polymer can be obtained as a latex.

Whereas another method for preparing water dispersion of polymers is also preferable, wherein into the polymer solution, water is added under vigorous stirring after addition of neutralizing agents or emulsifier agents.

For example, the polymer latex is obtained by emulsion polymerization at about 30° C. to 100° C., preferably at 60° C. to 90° C., for 3 hours to 24 hours with stirring using water or a mixed solvent of water and a water-miscible organic solvent (for example, methanol, ethanol, acetone, or the like) as a dispersion medium, and using a monomer mixture in an amount of 5% by mass to 150% by mass with respect to the dispersion solvent, an emulsifying agent, and a polymerization initiator. Conditions such as the dispersion medium, monomer concentration, the amount of the initiator, the amount of the emulsifying agent, the amount of the dispersing agent, the reaction temperature, and the adding method of the monomer may be appropriately determined considering the kind of the monomer used. The dispersing agent is preferably used, if necessary.

About the polymer latex that may be used in the invention, a water-based solvent may be used as the solvent in the solution for painting the latex. A water-miscible organic solvent may be used together. Examples of the water-miscible organic solvent include alcohols such as methyl alcohol, ethyl alcohol and propyl alcohol, cellosolves such as methylcellosolve, ethylcellosolve and butylcellosolve, ethyl acetate, and dimethylformamide. The added amount of the organic solvent is preferably 50% or less by mass, more preferably 30% or less by mass of the solvent.

About the polymer latex that may be used in the invention, the concentration of the polymer is preferably from 10 to 70% by mass, more preferably from 20 to 60% by mass, even more preferably from 30 to 55% by mass of the latex liquid. The polymer latex in the image-receiving sheet of the invention may be a substance in a state of a gel or dry coating film formed by volatilizing the solvent partially after the latex is painted.

[Emulsification Product]

In the invention, it is preferred that an emulsification product (emulsion) is contained in the receiving layer. This manner is in particular preferred when the polymer latex is used.

The definition of the word “emulsification” is in accordance with an ordinarily-used definition. According to, for example, “Chemical Big Dictionary” (published by Kyoritsu Shuppan Co., Ltd.), the word “emulsification” means a “phenomenon that a liquid is dispersed, in the form of fine particles, in another liquid that is insoluble in the liquid so as to generate an emulsion”. The wording “emulsification product” stands for “liquid droplets dispersed in a different liquid in which the droplets cannot be dissolved”. In the invention, a preferred example of the “emulsification product” is “oil droplets dispersed in water”. The content of the emulsification product in the image-receiving sheet in the invention is preferably from 0.03 to 25.0 g/m², more preferably from 1.0 to 20.0 g/m² in the sheet.

In the invention, it is preferred that a high boiling point solvent is contained as an oil-soluble component in the emulsification product. Preferred examples of the high boiling point solvent include phthalic esters (such as dibutyl phthalate, dioctyl phthalate, di-2-ethylhexyl phthalate), phosphoric esters or phosphonic esters (such as triphenyl phosphate, tricresyl phosphate, and tri-2-ethylhexyl phosphate), aliphatic acid esters (such as di-2-ethylhexyl succiante, and tributyl citrate), benzoic esters (2-ethylhexyl benzoate, dodecyl benzoate), amides (such as N,N-diethyldodecaneamide, and N,N-dimethyloleinamide), alcohols or phenols (such as isostearyl alcohol, and 2,4-di-tert-amylphenol), anilines (such as N,N-dibutyl-2-butoxy-5-tert-octylaniline), chlorinated paraffins, hydrocarbons (such as dodecylbenzene, and diisopropylnaphthalene), and carboxylic acids (such as 2-(2,4-di-tert-amylphenoxy)butyric acid. The high boiling point solvent is more preferably selected from phosphoric esters or phosphonic esters (such as triphenyl phosphate, tricresyl phosphate, and tri-2-ethylhexyl phosphate). It is allowable to use, as a co-solvent, an organic solvent having a boiling point of 30° C. or higher and 160° C. or lower (such as ethyl acetate, butyl acetate, methyl ethyl ketone, cyclohexanone, methylcellosolve acetate, or dimethylformamide) together. The high boiling point solvent is contained in the emulsification product preferably in an amount of 3.0 to 25% by mass, more preferably in an amount of 5.0 to 20% by mass of the product.

Furthermore, the emulsification product preferably contains an image-fastening agent or an ultraviolet absorbent. The compound therefor is preferably a compound represented by any one of general formulae (B), (Ph), (E-1) to (E-3), (TS-I) to (TS-VII), (TS-VIIIA) and (UA to UE) described in JP-A No. 2004-3619336. The emulsification product may also contain a water-insoluble and organic-solvent-soluble homopolymer or copolymer (preferably, compounds described in paragraph [0208] to[0234] in JP-A No. 2004-361936).

[Plasticizer]

In order to make the sensitivity of the receiving layer good, a plasticizer (high boiling point organic solvent) may be added thereto. The plasticizer may be a plasticizer that can be generally used as a plasticizer for vinyl chloride resin, such as a phthalic ester, a phosphoric ester, adipic ester, sebacic ester or any other monomeric plasticizer, or a polyester plasticizer, which is obtained by polymerizing adipic acid, sebacic acid or the like, and propylene glycol or the like. The plasticizers listed up above are generally low molecular weight ones; besides these plasticizers, an olefin especial copolymer resin, which is used as a polymeric plasticizer for vinyl chloride, may also be used. Resins used for such a purpose may be commercially available resins such as resins manufactured by Du Pont-Mitsui Polychemicals Co., Ltd. (trade names: Ellbaroy [transliteration] 741, Ellbaroy 742, Ellbaroy HP443, Ellbaroy HP553, Ellbaroy EP4015, Ellbaroy EP4043, and Ellbaroy EP4051. The plasticizer may be added in an amount of 100 parts by mass for 100 parts of the resin. Preferably, the amount is 30 parts or less by mass therefor in order to prevent the printed matter from oozing. When a polymer latex is used, it is preferred that the plasticizer is used as an emulsification product, as described above.

The receiving layer may be cast not by the painting of any solvent but by extrusion coating of a melted product of the above-mentioned polymer resin. Techniques of this extrusion coating are described in e.g., Encyclopedia of Polymer Science and Engineering, vol. 3, John Wiley, New York, 1885, p. 563, and vol. 6, 1986, p. 608. A technique for thermosensitive colorant transferring material is disclosed in JP-A No. 07-179075, and this technique can also be used preferably for the invention. The polymer resin is in particular preferably a copolymer obtained by polycondensing cyclohexanedicarboxylate and a mixture wherein ethylene glycol and bisphenol A-diethanol are mixed at a ratio by mole of 50/50 (registered trade name: COPOL).

[Releasing Agent]

Like a thermosensitive transfer ink sheet, it is possible to inject a releasing agent into a thermosensitive transfer image-receiving sheet. However, since ribbon creases are caused like a case of being contained in an ink sheet, it is necessary to limit a use amount. As a layer employing a releasing agent, a receiving layer is preferable.

Examples of the releasing agent include solid waxes such as polyethylene wax, amide wax, Teflon (registered trade name) powder, silicone oils, phosphoric ester compounds, fluorine-containing surfactants, silicone surfactants, and releasing agents known in the art. Preferred are fluorine-containing compounds, a typical example of which is a fluorine-containing surfactant; and silicone compounds, such as silicon surfactants, silicone oil and/or hardened products thereof.

The silicone oil may be straight silicone oil, modified silicone oil or hardened products thereof. Examples of the straight silicone oil include dimethyl silicone oil, methylphenyl silicone oil, and methylhydrogen silicone oil. Examples of the dimethyl silicone oil include oils manufactured by Shin-Etsu Chemical Co., Ltd. (trade names: KF96-10, KF96-100, KF96-1000, KF96H-10000, KF96H-12500, and KF96H-100000). Examples of the dimethyl silicone oil include oils manufactured by Shin-Etsu Chemical Co., Ltd. (trade names: KF50-100, KF54, and KF56).

The modified silicone oil can be classified into reactive silicone oil and unreactive silicone oil. Examples of the reactive silicone oil include amino-modified, epoxy-modified, carboxyl-modified, hydroxyl-modified, methacryl-modified, mercapto-modified, phenol-modified, single-terminal-reactive/different-functional-group-modified silicone oils. Examples of the amino-modified silicone oil include amino-modified silicone oils manufactured by Shin-Etsu Chemical Co., Ltd. (trade names: KF-393, KF-857, KF-858, X-22-3680, X-22-3801C, KF-8010, X-22-161A, and KF-8012). Examples of the epoxy-modified silicone oil include epoxy-modified silicone oils manufactured by Shin-Etsu Chemical Co., Ltd. (trade names: KF-100T, KF-101, KF-60-164, KF-103, X-22-343, and X-22-3000T). Examples of the carboxyl-modified silicone oil include a carboxyl-modified silicone oil manufactured by Shin-Etsu Chemical Co., Ltd. (trade name: X-22-162C). Examples of the hydroxyl-modified silicone oil include hydroxyl-modified silicone oils manufactured by Shin-Etsu Chemical Co., Ltd. (trade names: X-22-160AS, KF-6001, KF-6002, KF-6003, X-22-177DX, X-22-176DX, X-22-176D, and X-22-176DF). Examples of the methacryl-modified silicone oil include methacryl-modified silicone oils manufactured by Shin-Etsu Chemical Co., Ltd. (trade names: X-22-164A, X-22-164C, X-24-8201, X-22-174D, and X-22-2426.

The reactive silicone oil may be hardened and used. The hardened silicone oil can be classified into reaction hardened, light hardened, and catalyst hardened silicone oils, and others. Out of these oils, reaction hardened silicone oil is particularly preferred. The reaction hardened silicone oil is preferably silicone oil obtained by causing an amino-modified silicone oil and an epoxy-modified silicone oil to react with each other and harden. Examples of the catalyst hardened and light hardened silicone oils include catalyst hardened silicone oils manufactured by Shin-Etsu Chemical Co., Ltd. (trade names: KS-705F-PS, KS-705-PS-1, and KS-770-PL-3), and light hardened silicone oils manufactured by Shin-Etsu Chemical Co., Ltd. (trade names: KS-720, and KS-774-PL-3). The added amount of the hardened silicon oil is preferably from 0.5 to 30% by mass of the resins which constitute the receiving layer. The releasing agent is used usually in an amount of about 2 to 4% by mass of the polyester resin, preferably in an amount of about 2 to 3% by mass thereof. If an amount thereof is small, there is no effect of releasability. However, if too large, ribbon creases or transfer failure of a protecting layer to a thermosensitive transfer image-receiving sheet are/is caused.

Examples of the unreactive silicon oil include polyether modified, methylstyryl modified, alkyl modified, higher aliphatic acid ester modified, hydrophilic especially modified, higher alkoxy modified, and fluorine modified silicone oils. An example of the polyether modified silicone oil is a polyether modified oil manufactured by Shin-Etsu Chemical Co., Ltd. (trade name: KF-6012). An example of the methylstyryl modified silicon oil is a methylstyryl modified silicon oil manufactured by Shin-Etsu Chemical Co., Ltd. (trade name: 24-510). Moreover, a modified silicone represented by any one of the following formulae S1 to S3 may be used:

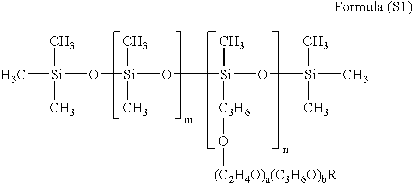

In the formula S1, R represents a hydrogen atom, or a linear or branched alkyl group which may be substituted with an aryl or cycloalkyl group, m and n each independently represents an integer of 2000 or less, and a and b each independently represents an integer of 30 or less.

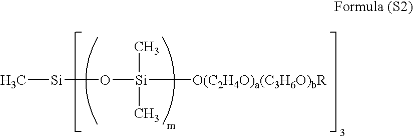

In the formula S2, R represents a hydrogen atom, or a linear or branched alkyl group which may be substituted with an aryl or cycloalkyl group, m represents an integer of 2000 or less, and a and b each independently represents an integer of 30 or less.

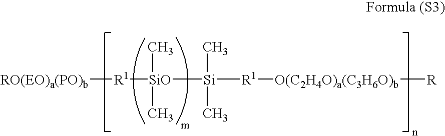

In the formula S3, R represents a hydrogen atom, or a linear or branched alkyl group which may be substituted with an aryl or cycloalkyl group, m and n each independently represents an integer of 2000 or less, a and b each independently represents an integer of 30 or less, and R¹ represents a single bond or a bivalent linking group, E represents an ethylene group or a substituted ethylene group, and P represents a propylene group or a substituted propylene group.

Silicone oils as described above are described in “Silicone Handbook” (published in the Nikkan Kogyo Shimbun, Ltd.). As a hardening technique for hardened silicone oil, a technique described in JP-A No. 08-108636 or 2002-264543 can be preferably used.

An abnormal transfer that a dye binder is transferred to a receiving layer in a highlight area in a monochromic printed matter may be caused. Hitherto, in addition polymerization type silicone, hardening reaction has been generally caused in the presence of a catalyst. It is known that almost all of complexes of group VIII transition metals, such as iron group metals and platinum group metals, are effective as the hardening catalyst; in general, platinum compounds are most effective. Usually, a platinum catalyst which is a platinum complex soluble in silicone oil is preferably used. The added amount necessary or sufficient for the reaction is from about 1 to 100 ppm.

This platinum catalyst has a strong interaction onto organic compounds containing N, P, S or the like, heavy metal ionic compounds of Sn, Pb, Hg, Bi, As or the like, and organic compounds containing a multiple bond such as an acetylene group; thus, when the catalyst is used together with such a compound (catalyst poison), the hydrosililating power of the catalyst is lost so that the catalyst will not fulfill a function as a hardening catalyst. As a result, the catalyst has a drawback of causing hardening-insufficiency of silicone (“Silicone Handbook” published in the Nikkan Kogyo Shuimbun, Ltd.). Thus, even if such an insufficiently hardened addition polymerization type silicone is used in the receiving layer, the layer does not exhibit peelability at all. It can be supposed that an isocyanate compound is used as a hardener reactive with active hydrogen. However, this isocyanate compound, or an organic tin isocyanate compound, which is the hardening catalyst above, corresponds to a catalyst poison of the platinum catalyst. Hitherto, therefore, addition polymerization type silicone has not been used together with any isocyanate compound. Thus, addition polymerization type silicone has not been used together with active-hydrogen-containing modified silicone, which is hardened by an isocyanate compound, thereby exhibiting peeling performance.

It is possible to prevent the intercept of the hardening of addition polymerization silicone 1) by setting the ratio of the reactive group equivalent of a hardener reactive with active hydrogen to the reactive group equivalent of both the thermoplastic resin and the modified silicone having active hydrogen into range of 1:1 to 10:1 and 2) by setting an amount of a platinum catalyst with respect to the addition polymerization type silicone, as platinum atom of the platinum catalyst, into the range of 100 to 10000 ppm. If the reactive group equivalent of the hardener reactive with active hydrogen in the 1) is not greater than 1, the amount of the thermoplastic resin and the silicone having the active hydrogen hardened by the active hydrogen is too small to obtain a good peelable performance. Conversely, if the equivalent ratio is more than 10, the time when the ink in the receiving layer coating-solution can be used is so short that the ink cannot be substantially used. If the amount of the platinum catalyst 2) is less than 100 ppm, the activity thereof is lost by catalytic poison. If the amount is more than 10000 ppm, the time when the ink in the receiving layer coating-solution can be used is so short that the ink cannot be used.

The applied amount of the receiving layer is preferably from 0.5 to 10 g/m² in terms of the amount of solid mattes therein. Any applied amount that will be described hereinafter in the present specification is a numerical value in terms of the amount of solid matters unless otherwise specified.

<Releasing Layer>

The hardened modified silicone oil may be added to a releasing layer formed on the receiving layer instead of being added to the receiving layer. In this case, the receiving layer may be made of one or more thermoplastic resins as described above, or may be a receiving layer to which a silicone is added. This releasing layer contains the hardened modified silicone oil, and the kind or the using method of the used silicone are the same as in the case that the silicone is used in the receiving layer. When a catalyst or a retardant is used in the releasing layer, the kind or the using method is the same as in the case that the agent is used in the receiving layer. The releasing layer may be made only of a silicone or may be made of a mixture of a silicone and a resin compatible therewith as a binder resin. The applied amount of this releasing layer is from about 0.001 to 1 g/m².

Examples of the fluorine-containing surfactant include surfactants manufactured by 3M Co. (trade names: FLUORADs FC-430, and FC-431).

<Underlying Layer>

It is preferred that an underlying layer is formed between the receiving layer and the support. For example, a white background adjusting layer, an electrostatic charge controlling layer, an adhesive layer, or a primer layer is formed. These layers may be formed in the same manner as described in Japanese Patent Nos. 3585599 and 2925244.

<Heat Insulating Layer>

The heat insulating layer functions to prevent heat radiated from the support in a case of heat and transfer using a thermal head or the like and to promote transfer of a dye. Even if a paper sheet is used as the support, a thermal transfer image-receiving sheet high in print sensitivity can be obtained since the heat insulating layer has a high cushion property. The heat insulating layer may be made of a single layer or two or more layers. The heat insulating layer is formed between the receiving layer and the support.

In the image-receiving sheet used in the invention, the heat insulating layer may contain a hollow polymer.

The hollow polymer in the invention is a particulate polymer having, in individual particles thereof, independent pores, and may be made of: [1] non-foamed hollow particles the insides of which are hollow, the particles being obtained by putting a dispersing medium such as water inside partitioning walls made of polystyrene, acrylic resin, styrene/acrylic component resin, or the like, painting and drying the resultant, and then vaporizing the dispersing medium in the particles to the outside of the particles; [2] foamed micro-balloons the insides of which are hollow, the balloons being obtained by covering a low boiling point liquid such as butane or pentane with a resin made of polyvinylidene chloride, polyacrylonitrile, polyacrylic acid or polyacrylic ester, or a mixture or a polymer thereof, painting the resultant, and then heating the resultant layer to swell the low boiling point liquid inside the particles; [3] micro-balloons obtained by heating and foaming the micro-balloons in the item [2] in advance; or the like.

The size of the particles of the hollow polymer is preferably from 0.1 to 20 μm, more preferably from 0.1 to 2 μm, even more preferably 0.1 to 1 μm, even more preferably 0.2 to 0.8 μm. If the size is too small, the hollow ratio tends to lower so that a desired heat insulating property cannot be obtained. If the size is too large, the particle diameter of the hollow polymer becomes too large for the film thickness of the heat insulating layer so that a flat plane is not easily obtained. As a result, coating failure based on coarse particles is easily caused.

The hollow ratio of the hollow polymer is preferably from about 20 to 70%, more preferably form 20 to 50%. If the hollow ratio is less than 20%, a sufficient heat insulating property is not obtained. If the hollow ratio is too high, the ratio of imperfectly hollow particles increases when the particle size is in a preferred range. As a result, a sufficient film strength cannot be obtained.

The hollow ratio of the hollow polymer in the invention is a value P calculated out from the following formula (a), using a transmission image obtained by photographing the hollow particles by transmission microscopic photography:

$$P = \{ 1 / n \times {\sum }_{i = 1}^{n} {( Rai / Rbi )}^{3} \} \times 100 ( \% ) \qquad Numerical formula ( a )$$

In the formula (a), Rai represents the circle equivalent diameter of the inner contour (hollow moiety contour) out of two contours which constitute the image of any one i of measured particles, Rbi represents the circle equivalent diameter of the outer contour (particle outline) out of the two contours, which constitute the image of the particle i, and n represents the number of the measured particles provided that n≧300.

The glass transition temperature (Tg) of the hollow polymer is preferably 70° C. or higher, more preferably 100° C. or higher. If necessary, the used hollow polymer may be made of a mixture of two or more hollow polymer species.

Such a hollow polymer is commercially available, and specific examples of the polymer in the item [1] include a polymer manufactured by Rohm and Haars Co. (trade name: ROHPEIK [transliteration] 1055), a polymer manufactured by Dainippon Ink & Chemicals, Inc. (trade name: PP-1000), a polymer manufactured by JSR Corp. (trade name: SX866(B)), and a polymer manufactured by Nippon Zeon Co., Ltd. (trade name: NIPPOL [transliteration] MH5055). Specific examples of the polymer in the item [2] include polymers manufactured by Matsumoto Yushi-Seiyaku Co., Ltd. (trade names: F-30 and F-50). Specific examples of the polymer in the item [3] include a polymer manufactured by Matsumoto Yushi-Seiyaku Co., Ltd. (trade name: F-30E), and polymers manufactured by Nippon Ferrite [transliteration] Co. (trade names: EXPANCELs [transliteration] 461DE, 551DE, and 551DE20). Out of these examples, the hollow polymers in the item {1} are more preferred.

It is preferred that the heat insulating layer containing the hollow polymer contains, as a binder resin, a water-dispersible resin or a water-soluble resin. This binder resin may be a known resin such as acrylic resin, styrene/acrylic component copolymer, polystyrene resin, polyvinyl alcohol resin, polyvinyl acetate resin, ethylene/vinyl acetate copolymer, vinyl chloride/vinyl acetate copolymer, styrene/butadiene copolymer, polyvinylidene chloride resin, a cellulose derivative, casein, starch or gelatin. In the invention, gelatin is in particular preferably used. These resins may be used alone or in a mixture form.

The content of solid matters of the hollow polymer in the heat insulating layer is preferably from 5 to 2000 parts by mass, more preferably from 5 to 1000 parts by mass, even more preferably from 5 to 400 parts by mass for 100 parts by mass of solid matters of the binder resin. The ratio by mass of the solid matters of the hollow polymer in the coating-solution is preferably from 10 to 80% by mass, more preferably from 30 to 70% by mass. If the ratio of the hollow polymer is too small, a sufficient heat insulating property cannot be obtained. If the ratio of the hollow polymer is too large, the binding power between molecules of the hollow polymer falls, whereby a sufficient film strength cannot be obtained so that the scratch resistance deteriorates.

In the image-receiving sheet used in the invention, the heat insulating layer should not contain any resin having no resistance against organic solvents besides the hollow polymer. If the heat insulating layer contains a resin having no resistance against organic solvents (colorant-dyeable resin), an image blur unfavorably increases after the image is transferred. It appears that this is caused by a matter that when the colorant-dyeable resin and the hollow resin are present in the heat insulating layer, the colorant dyed into the receiving layer after the image is transferred is shifted via the adjacent heat insulating layer with the passage of time.

The wording “resin having no resistance against organic solvents” means that the solubility of the resin in organic solvents (such as methyl ethyl ketone, ethyl acetate, benzene, toluene and xylene) is 1% or less by mass, preferably 0.5% or less by mass. For example, the above-mentioned polymer latex is contained in the category of the “resin having no resistance against organic solvents”.

The thickness of the heat insulating layer containing the hollow polymer is preferably from 5 to 50 μm, more preferably from 5 to 40 μm. The porosity of the heat insulating layer, which is calculated from the thickness of the heat insulating layer containing the hollow polymer and the solid-applied amount in this heat insulating layer, is preferably from 10 to 70%, more preferably from 15 to 60%. If the porosity of the heat insulating layer is less than 10%, a sufficient heat insulating property cannot be obtained. If the porosity is more than 70%, the binding power between molecules of the hollow polymer falls, whereby a sufficient film strength cannot be obtained so that the scratch resistance deteriorates.

In the invention, the porosity of the heat insulating layer is a value V calculated from the following formula (b):

V=1−L/L×Σgi·di Numerical formula (b)

In the formula (b), L represents the film thickness of the heat insulating layer, gi represents the solid-applied amount of any one i of materials which constitute the heat insulating layer, and di represents the specific gravity of the material i. When di represents the specific gravity of the hollow polymer, di represents the specific gravity of the wall material of the hollow polymer.

<Support>

The support used in the invention may be a water-resistant support. The use of the water-resistant support makes it possible to prevent water from being absorbed in the support to prevent a change in performances of the receiving layer with the passage of time. The water-resistant support may be made of, for example, coated paper or laminated paper.

—Coated Paper—

The coated paper is paper wherein one surface or both surfaces of a base paper sheet or some other sheet are coated with one or more selected from various resins, rubber latexes, and polymers. In accordance with the use manner of the image-receiving sheet, the applied amount thereof is varied. Examples of the coated paper include art paper, cast coated paper, and Yankee paper.

The resins that may be used for the coating of the surface(s) of the base paper or the like are appropriately thermoplastic resins. Examples of the thermoplastic resins include the following resins (A) to (H):

(A) Polyolefin resins such as polyethylene and polypropylene; copolymer resins each made from an olefin such as ethylene or propylene and another vinyl monomer; and acrylic resins.

(B) Thermoplastic resins having an ester bond, for example, a polyester resin, which is obtained by condensing a dicarboxylic acid, which may be substituted with a sulfonic group, a carboxyl group or the like, and an alcohol component, which may be substituted with a hydroxyl group or the like, a polyacrylic ester resin or polymethacrylic ester resin, such as polymethyl methacrylate, polybutyl methacrylate, polymethyl acrylate or polybutyl acrylate, polycarbonate resin, polyvinyl acetate resin, styrene/acrylate resin, styrene/methacrylate copolymer resin, and vinyltoluene/acrylate resin.

Specific examples thereof are described JP-A Nos. 59-101395. 63-7971, 63-7972, 63-7973, and 60-294862.

Examples of commercially available products thereof include resins manufactured by Toyobo Co., Ltd. (trade names: VYRON [transliteration] 290, VYRON 200, VYRON 280, VYRON 300, VYRON 103, VYRON GK-140, and VYRON GK-130; resins manufactured by Kao Corp. (trade names: TAFFTON [transliteration] NE-382, TAFFTON U-5, ATR-2009, and ATR-2010; resins manufactured by Unichika, Ltd. (trade names: ELEETELs [transliteration] UE3500, UE3210, XA-8153, KZA-7049, and KZA-1449; resins manufactured by the Nippon Synthetic Chemical Industry Co., Ltd. (trade names: POLYESTERs [transliteration] TP-220, and R-188; and thermoplastic resins in HIGHLOS [transliteration] series manufactured by Seiko Chemical industry Co., Ltd.

(C) Polyurethane resins

(D) Polyamide resins, and urea resins

(E) Polysulfone resins

(F) Polyvinyl chloride resin, polyvinylidene chloride resin, vinyl chloride/vinyl acetate copolymer resin, and vinyl chloride/vinyl propionate copolymer resin

(G) Polyol resins such as polyvinyl butyral resin, and cellulose resins such as ethylcellulose resin, and cellulose acetate resin

(H) Polycaprolactone resin, styrene/maleic anhydride resin, polyacrylonitrile resin, polyether resin, epoxy resin, and phenol resin.

These thermoplastic resins may be used alone or in combination of two or more thereof.

If necessary, a whitener, a condutant agent, a filler, a pigment or dye such as titanium oxide, ultramarine blue or carbon black, or the like may be incorporated into the thermoplastic resin.

—Laminated Paper—

The laminated paper is paper wherein one or more selected from various resin-, rubber- and polymer-sheets or films are laminated on a base paper sheet or some other sheet. Examples of the materials for the lamination include polyolefin, polyvinyl chloride, polyethylene terephthalate, polystyrene, polymethacrylate, polycarbonate, polyimide, and triacetylcellulose. These resins may be used alone or in combination of two or more thereof.

About the polyolefin, low density polyethylene is generally used to form a laminate in many cases. In order to improve the heat resistance of the support, it is preferred to use polypropylene, a blend of polypropylene and polyethylene, high density polyethylene, a blend of high density polyethylene and low density polyethylene, or the like. A blend of high density polyethylene and low density polyethylene is most preferably used particularly from the viewpoint of costs, laminate suitability, and others.

About the blend of high density polyethylene and low density polyethylene, the blend ratio by mass of the former to the latter is, for example, from 1/9 to 9/1, preferably from 2/8 to 8/2, more preferably from 3/7 to 7/3. When a thermoplastic resin layer is formed on each surface of the support, it is preferred that the rear surface of the support is made of high density polyethylene, or a blend of high density polyethylene and low density polyethylene. The molecular weight of the polyethylene is not particularly limited; about both of the high density polyethylene and the low density polyethylene, polyethylene having a melt index of 1.0 to 40 g/10-minutes and having extrusion-suitability is preferred.

A treatment for giving white reflectivity may be applied to the sheet or film. Such a treatment may be, for example, a treatment of incorporating a pigment such as titanium oxide into the sheet or film.

The thickness of the above-mentioned support is preferably from 25 to 300 μm, more preferably from 50 to 260 μm, even more preferably from 75 to 220 μm. About the rigidity of the support, various rigidities may be selected in accordance with the purpose thereof. About the support for an electrophotographic image-receiving sheet, which can give photographic image quality, the rigidity thereof is preferably a rigidity close to that of the support for color silver salt photograph.

<Curl Adjusting Layer>

If the support is naked, the thermosensitive transfer image-receiving sheet may be curled by the humidity or temperature of the environment; thus, a curl adjusting layer is preferably formed on the rear surface side of the support. The curl adjusting layer fulfils a function of not only preventing curling of the image-receiving sheet but also preventing water. For the curl adjusting layer, a polyethylene laminate, a polypropylene laminate or the like may be used. Specifically, the layer can be formed in the same way as described in JP-A Nos. 61-110135 and 06-202295, and others.

<Writing Layer and Electrostatic Charge Controlling Layer>

In the writing layer or the electrostatic charge controlling layer, an inorganic oxide colloid, an ionic polymer or the like can be used. This electrostatic charge controlling layer may contain any antistatic agent, and examples thereof include cationic antistatic agents such as tertiary ammonium salts and polyamide derivatives, anionic antistatic agents such as alkyl phosphates, and nonionic antistatic agents such as aliphatic acid esters. Specifically, the layer can be formed in the same way as described Japanese Patent No. 3585585.

The following will describe a process for producing the thermosensitive transfer image-receiving sheet of the invention.

The thermosensitive transfer image-receiving sheet of the invention can be formed by multi-painting at least one receiving layer, an intermediate layer, and a heat insulating layer on a support simultaneously.

In the case of forming, on a support, a multilayered image-receiving sheet having plurals layers having different functions (a foamed layer, a heat insulating layer, an intermediate layer, a receiving layer, and so on), it is known that this sheet is produced by painting the individual layers successively, as described in JP-A Nos. 2004-106283, 2004-181888, 2004-345267 and others, or by laminating products wherein the individual layers are each applied, in advance, onto a support onto each other. It is known in the photographic industry that plural layers are simultaneously multi-painted to improve the productivity largely. For example, the following methods are known: the so-called slide painting (slide coating) and curtain panting (curtain coating) described in U.S. Pat. Nos. 2,761,791, 2,681,234, 3,508,947, 4,457,256 and 3,993,019, JP-A Nos. 63-54975, 61-278848, 55-86557, 52-31727, 55-142565, 50-43140, 63-80872, 54-54020, 05-104061 and 05-127305, JP-B No. 49-7050, Edgar B. Gutoff et al., “Coating and Drying Defects: Troubleshooting Operating Problems”, John Wiley & Sons Co., 1995, pp. 101 to 103, and so on.

In the invention, the use of the above-mentioned simultaneous multi-painting in the production of the multilayered image-receiving sheet makes it possible to improve the productivity thereof largely and further reduce image defects largely.

In the invention, the plural layers are each made mainly of a resin. The painting (i.e., coating) solution for each of the layers is preferably a water-dispersive latex. The content by percentage of solid matters of the latex-state resin in the painting-solution for each of the layers is preferably from 5 to 80% by weight, more preferably from 20 to 60% by weight. The average particle size of the resin contained in the water-dispersive latex is preferably 5 μm or less, more preferably 1 μm or less. If necessary, the water-dispersive latex may contain known additives such as a surfactant, a dispersing agent, and a binder resin.

In the invention, it is preferred that after a laminate made of plural layers is formed on a support by the method described in U.S. Pat. No. 2,761,791, the laminate is rapidly solidified. In the case of an example wherein the laminate is a resin-cured multilayered structure, it is preferred that after plural layers are formed on a support, the temperature thereof is quickly raised. In the case that the laminate contains a binder which can be gelatinized at low temperature, such as gelatin, it may be preferred that after plural layers are formed on a support, the temperature thereof is rapidly lowered.

In the invention, the applied amount of the painting-solution for each of the layers which constitute the multilayered structure is preferably from 1 to 50 g/m². The number of the layers of the multilayered structure may be selected at will from numbers of 2 and more. It is preferred that the receiving layer is formed as a layer farthest from the support.

3) Image Formation

In the image forming process of the invention, the thermosensitive transfer image-receiving sheet and the thermosensitive transfer sheet are put on each other to bring the receiving layer of the former sheet and the thermal transfer layer of the latter sheet into contact with each other, and then thermal energy is supplied thereto from a thermal head in accordance with image signals, thereby forming an image.

Specifically, an image can be formed by the same method as described in, for example, JP-A No. 2005-88545. In the invention, the printing time is preferably less than 15 seconds, more preferably from 3 to 12 seconds, even more preferably from 3 to 7 seconds in order to shorten the time until a print matter is supplied to a consumer.

In order to satisfy the above-mentioned printing time, the line speed in the printing is preferably 0.73 msecond/line or less, more preferably 0.65 msecond/line. The highest temperature of the thermal head in the printing is preferably 180° C. or higher and 450° C. or lower, more preferably 200° C. or higher and 450° C. or lower, even more preferably 350° C. or higher and 450° C. or lower in order to improve the transfer efficiency under high-speed printing conditions.

In the invention, a printer or copying machine using a thermosensitive transfer printing manner may be used. About the means for supplying thermal energy when an image is thermally transferred, any known means for supplying such energy can be used. The printing time is controlled with a printing device, such as a thermal printer (trade name of an example thereof: VIDEO PRINTER VY-100, manufactured by Hitachi Ltd.), thereby supplying a thermal energy of about 5 to 100 mJ/mm². In this way, a desired purpose can be sufficiently attained. The thermosensitive transfer image-receiving sheet of the invention can be applied to thermal-transfer-printable, sheet-form or roll-form thermosensitive transfer image-receiving sheets, cards, sheets for preparing a transmission type manuscript, and other articles.

### EXAMPLES

The present invention will be described in detail by way of the following examples; however, the invention is not limited thereto. In the examples, the word “part(s)” and the symbol “%” mean “part(s) by mass” and “% by mass”, respectively, unless otherwise specified.

[Formation of Thermosensitive Transfer Ink Sheet 101]

### Preparation of Thermosensitive Transfer Ink Sheet Painting-Solution and Protecting Layer Painting-Solution:

The following painting-solutions were prepared to form a thermosensitive transfer ink sheet.

### Composition of Painting-Solution PY-1 for Yellow Thermosensitive Transfer Layer:

| | |
|---|---|
| Yellow dye Y1-7: | 4.1 parts by mass |
| Yellow dye Y2-6: | 4.1 parts by mass |
| Polyvinyl acetoacetal resin (trade name: | 8.0 parts by mass |
| ESLEX [transliteration] KS-1, | |
| manufactured by Sekisui Chemical Co., Ltd.): | |
| Polyvinyl butyral resin (trade name: | 0.2 parts by mass |
| DENKA BUTYRAL #6000-C, manufactured by | |
| Denki Kagaku Kogyo Kabushiki Kaisha): | |
| Compound P-1 specified in the invention: | 0.8 parts by mass |
| Mat agent (trade name: FLOUCENE | 0.15 parts by mass |
| [transliteration] UF, manufactured | |
| by Sumitomo Seika Chemicals Co., Ltd.): | |
| Methyl ethyl ketone/toluene (ratio by mass: 2/1): | 84 parts by mass |

### Composition of Painting-Solution PM-1 for Magenta Thermosensitive Transfer Layer:

| | |
|---|---|
| Magnet dye M1-2: | 0.1 parts by mass |
| Magnet dye M2-1: | 0.7 parts by mass |
| Magnet dye M2-3: | 6.6 parts by mass |
| Cyan dye C2-2: | 0.4 parts by mass |
| Polyvinyl acetoacetal resin (trade name: | 8.0 parts by mass |
| ESLEX [transliteration] KS-1, manufactured | |
| by Sekisui Chemical Co., Ltd.): | |
| Polyvinyl butyral resin (trade name: DENKA | 0.2 parts by mass |
| BUTYRAL #6000-C, manufactured by | |
| Denki Kagaku Kogyo Kabushiki Kaisha): | |
| Compound P-1 specified in the invention: | 0.8 parts by mass |
| Mat agent (trade name: FLOUCENE | 0.15 parts by mass |
| [transliteration] UF, manufactured by | |
| Sumitomo Seika Chemicals Co., Ltd.): | |
| Methyl ethyl ketone/toluene (ratio by mass = 2/1): | 84 parts by mass |

### Composition of Painting-Solution PC-1 for Cyan Thermosensitive Transfer Layer:

| | |
|---|---|
| Cyan dye C1-3: | 1.6 parts by mass |
| Cyan dye C2-2: | 6.6 parts by mass |
| Polyvinyl acetoacetal resin (trade name: ESLEX | 8.0 parts by mass |
| [transliteration] KS-1, manufactured by | |
| Sekisui Chemical Co., Ltd.): | |
| Polyvinyl butyral resin (trade name: DENKA | 0.2 parts by mass |
| BUTYRAL #6000-C, manufactured by Denki | |
| Kagaku Kogyo Kabushiki Kaisha): | |
| Compound P-1 specified in the invention: | 0.8 parts by mass |
| Mat agent (trade name: FLOUCENE | 0.15 parts by mass |
| [transliteration] UF, manufactured | |
| by Sumitomo Seika Chemicals Co., Ltd.): | |
| Methyl ethyl ketone/toluene (ratio by mass = 2/1): | 84 parts by mass |

### Composition of Releasing Layer Painting-Solution PU1 for Thermally-Transferable Protecting Layer:

| | |
|---|---|
| Modified cellulose resin (trade name: L-30, | 5 parts by mass |
| manufactured by Daicel Chemical Industries, Ltd.): | |
| Methyl ethyl ketone: | 95 parts by mass |

### Composition of Peelable Layer Painting-Solution PU1 for Thermally-Transferable Protecting Layer:

| | |
|---|---|
| Acrylic resin solution (solid content: 40%) | 90 parts by mass |
| (trade name: UNO-1, manufactured by Gifu Ceramic | |
| [transliteration] Corp.: | |
| Methanol/isopropanol (ratio by mass: 1/1): | 10 parts by mass |

### Composition of Adhesive Layer Painting-Solution A1 for Thermally-Transferable Protecting Layer:

Acrylic resin (trade name: DIANAAL [transliteration] BR-77,
manufactured by Mitsubishi Rayon Co., Ltd.):

| | 25 parts by mass |
|---|---|
| Ultraviolet absorbent UV-1 illustrated below: | 1 part by mass |
| Ultraviolet absorbent UV-2 illustrated below: | 2 parts by mass |
| Ultraviolet absorbent UV-3 illustrated below: | 1 part by mass |
| Ultraviolet absorbent UV-4 illustrated below: | 1 part by mass |
| PMMA fine particles: 0.4 part | |
| Methyl ethyl ketone/toluene (ratio by mass: 2/1): | 70 parts by mass |

(UV-1)

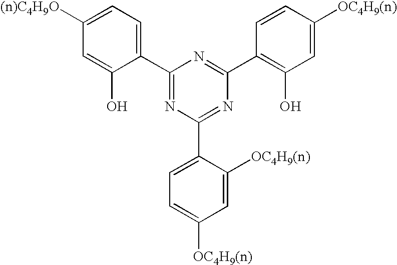

(UV-2)

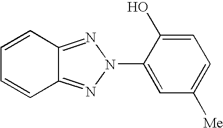

(UV-3)

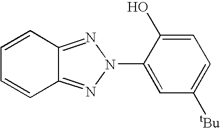

(UV-4)

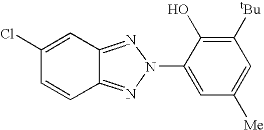

### Preparation of Painting-Solution for Heat-Resistant Lubricant Layer:

A painting-solution described below was prepared to form a heat-resistant lubricant layer of the thermosensitive transfer ink sheet.

### Composition of Backside Layer Painting-Solution BC1:

| | |
|---|---|
| Acrylic polyol resin (trade name: ACRYDICK | 26.0 parts by mass |
| [transliteration] A-801, manufactured by | |
| Dainippon Ink & Chemicals, Inc.): | |
| Zinc stearate (trade name: SZ-2000, manufactured | 0.43 parts by mass |
| by Sakai Chemical Industry Co., Ltd.): | |
| Phosphoric ester (trade name: PLYSURL | 1.27 parts by mass |
| [transliteration] A217, manufactured by | |
| Daiichi Kogyo Seiyaku Co., Ltd.: | |
| Isocyanate (50% solution) (trade name: BERNOCK | 8.0 parts by mass |
| [transliteration] D-800, manufactured | |
| by Dainippon Ink & Chemicals, Inc.): | |
| Methyl ethyl ketone/toluene (ratio by mass: 2/1): | 64 parts by mass |

Formation of Sheet by Painting the Painting-Solutions:

As a support, prepared was a polyester film 6.0 μm in thickness (trade name: DIAHOYL)[transliteration] K200E-6F, manufactured by Mitsubishi Polyester Film GmbH), a single surface of which was subjected to easily-bonding treatment. The heat-resistant lubricant layer painting-solution BC1 was painted onto the film surface not subjected to the easily-bonding treatment to give a solid matter applied amount of 1 g/m after the painted solution was dried. After the painted solution was dried, the resultant layer was subjected to thermal treatment at 60° C. so as to be hardened.

The above-mentioned painting-solutions were plane-wise and successively painted onto the easily-bonding treatment side of the polyester film formed as described above, so as to form, on the side, yellow, magenta and cyan thermal transfer layers and a protecting layer successively. In this way, a thermosensitive transfer ink sheet 101 was formed. At the time of forming the protecting layer, the releasing layer painting-solution PU1 for the protecting layer was painted and then dried, the peelable layer painting-solution PO1 for the protecting layer was painted and then dried, and further the adhesive layer painting-solution A1 for the protecting layer was painted.

About each of the applied amounts at this time, the solid matter applied amount was adjusted to be set as follows:

| | |
|---|---|
| Yellow thermal transfer layer: | 0.8 g/m² |
| Magnet thermal transfer layer: | 0.8 g/m² |
| Cyan thermal transfer layer: | 0.8 g/m² |
| Releasing layer for the Protecting layer: | 0.3 g/m² |
| Peelable layer for the protecting layer: | 0.5 g/m² |
| Adhesive layer for the protecting layer: | 2.0 g/m² |

[Formation of Thermosensitive Transfer Ink Sheet 102]

A thermosensitive transfer ink sheet 102 was formed in the same way as in the formation of the thermosensitive transfer ink sheet 101 except that the compound P-1 specified in the invention added to each of the dye layers was changed to a compound L-1 in the invention.

| | |
|---|---|
| Compound L-1 in the invention: | 0.8 parts by mass |

[Formation of Thermosensitive Transfer Ink Sheet 103]

A thermosensitive transfer ink sheet 103 was formed in the same way as in the formation of the thermosensitive transfer ink sheet 101 except that the compound P-1 specified in the invention added to each of the dye layers was changed to a compound F-1 in the invention.

| | |
|---|---|
| Compound F-1 in the invention: | 0.8 parts by mass |

(F-1)

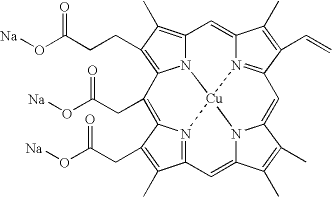

[Formation of Thermosensitive Transfer Ink Sheet 104]

A thermosensitive transfer ink sheet 104 was formed in the same way as in the formation of the thermosensitive transfer ink sheet 101 except that the compound P-1 specified in the invention added to each of the dye layers was changed to following compounds specified in the invention.

| | |
|---|---|
| Compound P-1 specified in the invention: | 0.4 parts by mass |
| Compound F-1 in the invention: | 0.4 parts by mass |

[Formation of Thermosensitive Transfer Ink Sheet 105]

A thermosensitive transfer ink sheet 105 was formed in the same way as in the formation of the thermosensitive transfer ink sheet 101 except that the compound P-1 specified in the invention added to each of the dye layers was changed to a following compound specified in the invention.

| | |
|---|---|
| Compound P-2 in the invention: | 0.8 parts by mass |

[Formation of Thermosensitive Transfer Ink Sheet 106]

A thermosensitive transfer ink sheet 106 was formed in the same way as in the formation of the thermosensitive transfer ink sheet 101 except that the compound P-1 specified in the invention added to each of the dye layers was changed to a following compound specified in the invention.

| | |
|---|---|
| Compound L-2 in the invention: | 0.8 parts by mass |

[Formation of Thermosensitive Transfer Ink Sheet 107]

A thermosensitive transfer ink sheet 107 was formed in the same way as in the formation of the thermosensitive transfer ink sheet 101 except that the compound P-1 specified in the invention added to each of the dye layers was changed to the following silicone-based comparative compounds:

| | |
|---|---|
| Silicone-based comparative compound 1 | 0.05 parts by mass |
| (trade name: X-22-3000T, manufactured | |
| by Shin-Etsu Chemical Co., Ltd.): | |
| Silicone-based comparative compound 2 | 0.03 parts by mass |
| (trade name: TSF 4701, manufactured by | |
| Momentive Performance material Japan LLC): | |

[Formation of Thermosensitive Transfer Ink Sheet 108]

A thermosensitive transfer ink sheet 108 was formed in the same way as in the formation of the thermosensitive transfer ink sheet 101 except that the compound P-1 specified in the invention added to each of the dye layers was changed to the following silicone-based comparative compounds:

| | |
|---|---|
| Silicone-based comparative compound 1 | 0.25 parts by mass |
| (trade name: X-22-3000T, manufactured | |
| by Shin-Etsu Chemical Co., Ltd.): | |
| Silicone-based comparative compound 2 | 0.15 parts by mass |
| (trade name: TSF 4701, manufactured by | |
| Momentive Performance material Japan LLC): | |

[Formation of Thermosensitive Transfer Ink Sheet 109]

A thermosensitive transfer ink sheet 109 was formed in the same way as in the formation of the thermosensitive transfer ink sheet 101 except that the compound P-1 specified in the invention added to each of the dye layers was changed to the following comparative compound of phthalocyanine precursor (H-1):

| | |
|---|---|
| Comparative compound of phthalocyanine precursor (H-1): | 0.8 parts by mass |

(H-1)

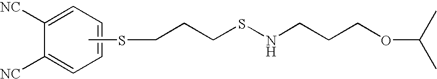

[Formation of Thermosensitive Transfer Ink Sheet 110]

A thermosensitive transfer ink sheet 110 was formed in the same way as in the formation of the thermosensitive transfer ink sheet 101 except that the compound P-1 specified in the invention added to each of the dye layers was changed to the following comparative compound of phthalocyanine precursor (H-2):

| | |
|---|---|
| Comparative compound of phthalocyanine | 0.8 parts by mass |
| precursor (H-2): | |

(H-2)

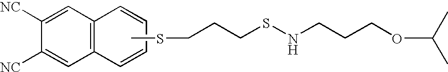

[Formation of Thermosensitive Transfer Ink Sheet 111]

A thermosensitive transfer ink sheet 111 was formed in the same way as in the formation of the thermosensitive transfer ink sheet 101 except that no compound specified in the invention and no comparative compound were used in each of the dye layers.

[Formation of Thermosensitive Transfer Ink Sheet 201]

Both surfaces of a paper support, polyethylene being laminated on the surfaces, were subjected to corona discharge treatment, and then a gelatin underlying layer containing sodium dodecylbenzenesulfonate was formed on one of the surfaces. Undercoating layer, heat insulating layer, lower receiving layer, and upper receiving layer painting-solutions each having a composition described below were then multilayer-painted by a method illustrated in FIG. 9 in U.S. Pat. No. 2,761,791 so as to form, on the underlying layer, an undercoating layer, a heat insulating layer, a lower receiving layer and an upper receiving layer, these layers being laminated in this order from the side of the support. When the painting-solutions were dried, the applied amounts thereof were as follows: the undercoating layer painting-solution: 6.7 g/m²; the heat insulating layer painting-solution: 8.6 g/m²; the lower receiving layer painting-solution: 2.6 g/m²; and the upper receiving layer painting-solution: 2.7 g/m².

Composition of Upper Receiving Layer Painting-Solution:

| | |
|---|---|
| Vinyl chloride based latex (trade name: VINYBRANE [transliteration]900, manufactured | 22.2 parts by mass (as the amount of |
| by Nissin Chemical Industry Co., Ltd.): | solid matters therein) |
| Vinyl chloride based latex (trade name: VINYBRANE [transliteration]276, manufactured by | 2.5 parts by mass (as the amount of |
| Nissin Chemical Industry Co., Ltd.): | solid matters therein) |
| Gelatin: | 0.5 parts by mass |
| Ester wax EW-1 illustrated below: | 2.0 parts by mass |
| Surfactant F-1 illustrated below: | 0.04 parts by mass |

Composition of Lower Receiving Layer Painting-Solution:

| | |
|---|---|
| Vinyl chloride based latex (trade name: VINYBRANE [transliteration]690, manufactured | 24.4 parts by mass (as the amount of |
| by Nissin Chemical Industry Co., Ltd.): | solid matters therein) |
| Gelatin: | 1.4 parts by mass |
| Surfactant F-1 illustrated below: | 0.04 parts by mass |

Composition of Heat Insulating Layer Painting-Solution:

| | |
|---|---|
| Hollow polymer particle latex (trade name: MH 5055, manufactured by Nippon Zeon Co., | 579 parts by mass (as the amount of |
| Ltd.): | solid matters therein) |
| Gelatin: | 279 parts by mass |

Composition of Undercoating Layer Painting-Solution

| | |
|---|---|
| Polyvinyl alcohol (trade name: POVAL PVA2O5, manufactured by Kuraray Co., Ltd.): | 16.8 parts by mass |
| Styrene butadiene rubber latex (trade name: SN-3 07, manufactured by Nippon A & L | 150 parts by mass (as the amount of |
| Inc.): | solid matters therein) |
| Surfactant F-1 illustrated below: | 0.1 parts by mass |

(EW-1)

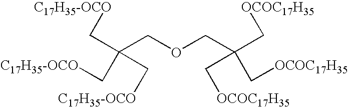

(F-1)

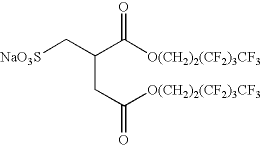

[Formation of Thermosensitive Transfer Image-Receiving Sheet 202]

As a support, a synthetic paper piece 200 μm in thickness (trade name: YUPO [transliteration] FPG200, manufactured by Yupo Corp.) was used. Heat insulating layer and receiving layer painting-solutions each having a composition described below were painted, in this order, onto one of the surfaces of the paper piece with a bar coater. The painting was performed in such a manner that when each of the painting-solutions was dried, the applied amount thereof was set to 4.0 g/m². The drying for each of the layers was performed at 110° C. for 30 seconds.

Composition of Receiving Layer Painting-Solution:

| | |
|---|---|
| Vinyl chloride/vinyl acetate resin (trade name: | 100 parts by mass |
| SOLVAIN [transliteration] A, manufactured by | |
| Nissin Chemical Industry Co., Ltd.): | |
| Amino-modified silicone (trade name: X22-3050C, | 5 parts by mass |
| manufactured by Shin-Etsu Chemical Co., Ltd.): | |
| Epoxy-modified silicone (trade name: X22-3000E, | 5 parts by mass |
| manufactured by Shin-Etsu Chemical Co., Ltd.): | |
| Methyl ethyl ketone/toluene (ratio by mass: 1/1): | 400 parts by mass |

Composition of Heat Insulating Layer Painting-Solution:

| | |
|---|---|
| Hollow polymer particle latex (trade name: MH | 579 parts by mass |
| 5055, manufactured by Nippon Zeon Co., Ltd.): | (as the amount of |
| | solid matters therein) |
| Gelatin: | 279 parts by mass |

[Formation of Images]

The thermal transfer sheets of the present invention and the comparative examples, and image-receiving sheets were worked in such a manner that they were able to be fitted to a sublimation mode thermal transfer printer (trade name: ASK 2000, manufactured by Fuji Photo Film Co., Ltd.). In a high-speed print mode thereof, images were outputted. At this time, the line speed was 0.65 millisecond/line, and the highest temperature of its thermal printing head was 400° C.

[Evaluation Test]

Digital information images, which were black solid images ((R, G, B)=(0, 0, 0)) having a KG size, were printed on 30 image-receiving sheets, using 30 samples of each of the thermal transfer sheets of the present invention and the comparative examples. About blocking based on transfer failure, it was checked whether the generation thereof was observed with the naked eye. Even if the generation of blocking was observed in only one out of the 30 sheets, it was decided that blocking was generated.

Next, the transfer density (Dmax) was evaluated. Digital information images, which were magenta solid images ((R, G, B)=(255, 0, 255)) having a KG size, were printed on 10 image-receiving sheets, using 10 samples of each of the thermal transfer sheets of the present invention and the comparative examples. In order to measure the transfer density of the images, a device (trade name: X-rite 530LP, manufactured by X-rite Co.) was used to measure, as the average of data of 20 points about each of the image surfaces, the M density of the image areas where no blocking was generated.

The results are shown in Table 3.

TABLE 3

| | | Thermosensitive | | | |
|---|---|---|---|---|---|
| | | transfer | | | |
| | Thermosensitive | image- | | | |
| Experiment | transfer | receiving | | Transfer | |
| No. | ink sheet | sheet | Blocking | density | Notes |
| 1 | 101 | 201 | A (Not generated) | 2.11 | The Invention |
| 2 | 101 | 202 | A (Not generated) | 2.12 | The Invention |
| 3 | 102 | 201 | A (Not generated) | 2.09 | The Invention |
| 4 | 102 | 202 | A (Not generated) | 2.10 | The Invention |
| 5 | 103 | 201 | A (Not generated) | 2.09 | The Invention |
| 6 | 104 | 201 | A (Not generated) | 2.11 | The Invention |
| 7 | 105 | 201 | A (Not generated) | 2.09 | The Invention |
| 8 | 106 | 201 | A (Not generated) | 2.10 | The Invention |
| 9 | 107 | 201 | C (Generated) | 2.09 | Comparative |
| | | | | | Example |
| 10 | 108 | 201 | A (Not generated) | 1.89 | Comparative |
| | | | | | Example |
| 11 | 109 | 201 | C (Generated) | 2.11 | Comparative |
| | | | | | Example |
| 12 | 110 | 201 | C (Generated) | 2.09 | Comparative |
| | | | | | Example |
| 13 | 111 | 201 | C (Generated) | 2.10 | Comparative |
| | | | | | Example |

From the results in Table 3, it can be understood that the thermosensitive transfer ink sheet of the invention can restrain blocking without reducing the transfer density of images.

According to the invention, it is possible to provide a thermosensitive transfer ink sheet which is excellent in continuous printing performance and does not give a defective image easily, and an image forming method using the same.

Further, according to the exemplary embodiments of the invention, it is possible to provide the following items of <1> to <13>. However, the present invention is not restricted to the following items.

<1>; A thermosensitive transfer ink sheet, comprising a base film which has, over one surface thereof, a thermal transfer layer containing at least a thermally transferable dye and a binder resin, and has, over the other surface thereof, a heat-resistant lubricant layer, wherein the thermal transfer layer comprises a polycondensed aromatic compound having 4 or more rings.

<2>; The thermosensitive transfer ink sheet according to item <1>, wherein the added amount of the polycondensed aromatic compound having 4 or more rings is from 0.1% by mass to 10% by mass of the binder resin.

<3>; The thermosensitive transfer ink sheet according to item <1> or <2>, wherein the polycondensed aromatic compound having 4 or more rings is a phthalocyanine compound.

<4>; The thermosensitive transfer ink sheet according to item <3>, wherein the phthalocyanine compound is represented by the following formula (1):

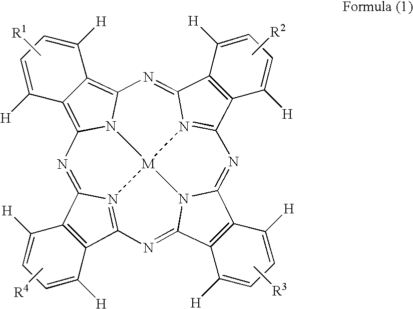

wherein in formula (1), R¹, R², R³ and R⁴ each independently represents a hydrogen atom, or a monovalent substituent; and M represents a hydrogen atom, a metal element, or an oxide, hydroxide or halide thereof.

<5>; The thermosensitive transfer ink sheet according to item <1> or <2>, wherein the polycondensed aromatic compound having 4 or more rings is a triphenylene compound.

<6>; The thermosensitive transfer ink sheet according to item <5>, wherein the triphenylene compound is represented by the following formula (2):

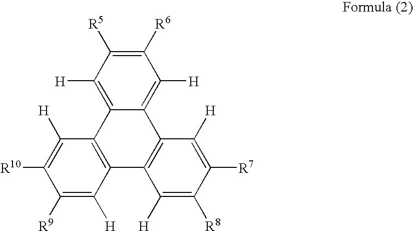

wherein in formula (2), R⁵, R⁶, R⁷, R⁸, R⁹ and R¹⁰ each independently represents a hydrogen atom or a monovalent substituent.

<7>; An image forming method, comprising:

putting a thermosensitive transfer ink sheet comprising a base film which has, over one surface thereof, a thermal transfer layer containing at least a thermally transferable dye and a binder resin, and has, over the other surface thereof, heat-resistant lubricant layer wherein the thermal transfer layer comprises a polycondensed aromatic compound having 4 or more rings onto a thermosensitive transfer image-receiving sheet which has a support, at least one dye receiving layer over the support, and at least one heat insulating layer arranged between the dye receiving layer and the support and containing hollow polymer particles and a hydrophilic polymer to bring the thermal transfer layer of the thermosensitive transfer ink sheet into contact with the dye receiving layer of the thermosensitive transfer image-receiving sheet; and

applying thermal energy corresponding to an image signal thereto from a thermal head.

<8>; The image forming method according to item <7>, wherein the added amount of the polycondensed aromatic compound having 4 or more rings is from 0.1% by mass to 10% by mass of the binder resin.

<9>; The image forming method according to item <7> or <8>, wherein the polycondensed aromatic compound having 4 or more rings is a phthalocyanine compound.

<10>; The image forming method according to item <9>, wherein the phthalocyanine compound is represented by the following formula (1):

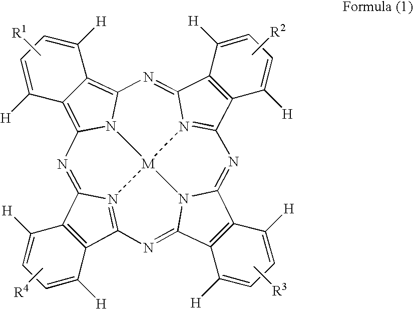

wherein in formula (1), R¹, R², R³ and R⁴ each independently represents a hydrogen atom, or a monovalent substituent, and M represents a hydrogen atom, a metal element or an oxide, hydroxide or halide thereof.

<11>; The image forming method according to item <7> or <8>, wherein the polycondensed aromatic compound having 4 or more rings is a triphenylene compound.

<12>; The image forming method according to item <11>, wherein the triphenylene compound is represented by the following formula (2):

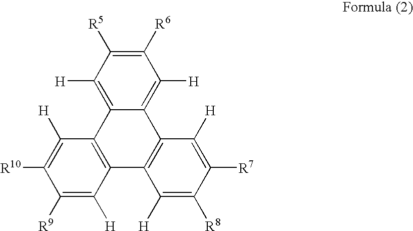

wherein in formula (2), R⁵, R⁶, R⁷, R⁸, R⁹ and R¹⁰ each independently represents a hydrogen atom or a monovalent substituent.

<13>; The image forming method according to any one of items <7> to <12>, wherein the hydrophilic polymer contained in the heat insulating layer in the thermosensitive transfer image-receiving sheet comprises gelatin.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. The scope of the invention, therefore, should be determined by the following claims.

What is claimed is:

1. A thermosensitive transfer ink sheet comprising a base film which has, over one surface thereof, a thermal transfer layer containing at least a thermally transferable dye and a binder resin, and has, over the other surface thereof, a heat-resistant lubricant layer, wherein the thermal transfer layer comprises a polycondensed aromatic compound having 4 or more rings.

2. The thermosensitive transfer ink sheet according to claim 1, wherein the added amount of the polycondensed aromatic compound having 4 or more rings is from 0.1% by mass to 10% by mass of the binder resin.

3. The thermosensitive transfer ink sheet according to claim 1, wherein the polycondensed aromatic compound having 4 or more rings is a phthalocyanine compound.

4. The thermosensitive transfer ink sheet according to claim 3, wherein the phthalocyanine compound is represented by the following formula (1): 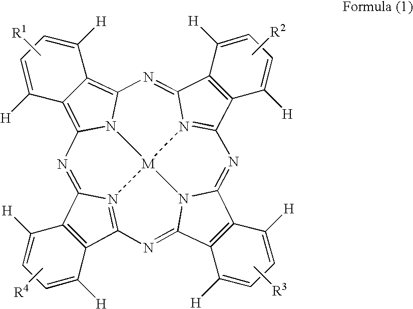
wherein in formula (1), R¹, R², R³ and R⁴ each independently represents a hydrogen atom or a monovalent substituent; and M represents a hydrogen atom, a metal element or an oxide, hydroxide or halide thereof.

5. The thermosensitive transfer ink sheet according to claim 1, wherein the polycondensed aromatic compound having 4 or more rings is a triphenylene compound.

6. The thermosensitive transfer ink sheet according to claim 5, wherein the triphenylene compound is represented by the following formula (2): 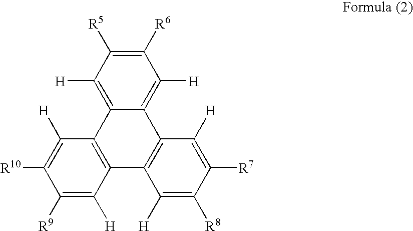
wherein in formula (2), R⁵, R⁶, R⁷, R⁸, R⁹ and R¹⁰ each independently represents a hydrogen atom or a monovalent substituent.

7. An image forming method comprising:
putting a thermosensitive transfer ink sheet comprising a base film which has, over one surface thereof, a thermal transfer layer containing at least a thermally transferable dye and a binder resin, and has, over the other surface thereof, heat-resistant lubricant layer wherein the thermal transfer layer comprises a polycondensed aromatic compound having 4 or more rings onto a thermosensitive transfer image-receiving sheet which has a support, at least one dye receiving layer over the support, and at least one heat insulating layer arranged between the dye receiving layer and the support and containing hollow polymer particles and a hydrophilic polymer to bring the thermal transfer layer of the thermosensitive transfer ink sheet into contact with the dye receiving layer of the thermosensitive transfer image-receiving sheet; and applying thermal energy corresponding to an image signal thereto from a thermal head.

8. The image forming method according to claim 7, wherein the added amount of the polycondensed aromatic compound having 4 or more rings is from 0.1% by mass to 10% by mass of the binder resin.

9. The image forming method according to claim 7, wherein the polycondensed aromatic compound having 4 or more rings is a phthalocyanine compound.

10. The image forming method according to claim 9, wherein the phthalocyanine compound is represented by the following formula (1): 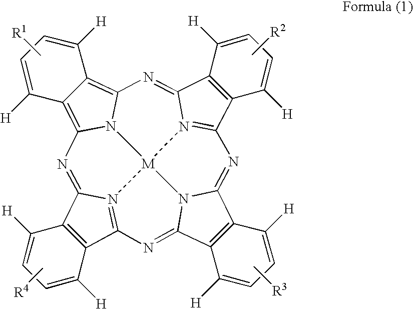
wherein in formula (1), R¹, R², R³ and R⁴ each independently represents a hydrogen atom or a monovalent substituent; and M represents a hydrogen atom, a metal element or an oxide, hydroxide or halide thereof.

11. The image forming method according to claim 7, wherein the polycondensed aromatic compound having 4 or more rings is a triphenylene compound.

12. The image forming method according to claim 11, wherein the triphenylene compound is represented by the following formula (2): 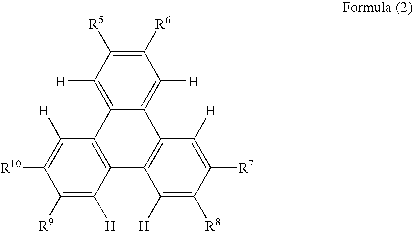
wherein in formula (2), R⁵, R⁶, R⁷, R⁸, R⁹ and R¹⁰ each independently represents a hydrogen atom or a monovalent substituent.

13. The image forming method according to claim 7, wherein the hydrophilic polymer contained in the heat insulating layer in the thermosensitive transfer image-receiving sheet comprises gelatin.
